(19) United States
(12) Patent Application Publication
(10) Pub. No.: US 2026/0147542 A1
(43) Pub. Date: May 28, 2026

(54) REAL-TIME SEQUENTIAL CODE RECOMMENDATIONS WITH SYNTACTICALLY COMPLETE CODE COMPLETIONS

(71) Applicant: Amazon Technologies, Inc., Seattle, WA (US)

(72) Inventors: Thomas LJ Cottenier, Sammamish, WA (US); Varun Kumar, Santa Clara, CA (US); Xiaofei Ma, New York, NY (US); Murali Krishna Ramanathan, Los Altos, CA (US); Srinivas Iragavarapu, Redmond, WA (US); Yanitsa Donchev, Kirkland, WA (US); Ningke Hu, Bellevue, WA (US); Matthew Lee, Elmhurst, NY (US); Anoop Deoras, San Jose, CA (US); Zijian Wang, Sunnyvale, CA (US)

(21) Appl. No.: 18/962,336

(22) Filed: Nov. 27, 2024

(51) Int. Cl. G06F 8/30

(52) U.S. Cl. CPC G06F 8/30

(57) ABSTRACT

Disclosed are systems and methods that address the limitations of current code completion techniques, generate multiple levels of syntactically complete code completions, each level of syntactically complete code completion based upon and dependent upon an acceptance of a prior level syntactically complete code completion. A first level syntactically complete code completion may be presented as a suggestion for inclusion in a code and each additional level of syntactically complete code completions in the sequence maintained in a cache so that the next level syntactically complete code completion can be presented immediately upon acceptance of the currently presented syntactically complete code completion. By pre-generating multiple levels of syntactically complete code completions so that each next level syntactically complete code completion can be presented immediately upon acceptance of a presented syntactically complete code completion reduces or eliminates any perceived latency in code completion generation and/or code completion presentation.

### BACKGROUND

Machine learning (ML) refers to a discipline by which computer systems can be trained to recognize patterns through repeated exposure to training data. The use of a trained model in production is often referred to as “inference,” during which the model receives new data that was not in its training data set and provides an output based on its learned parameters. In contrast to machine learning (ML), artificial intelligence (AI) refers to a human perception of a computer system as possessing a capability typically considered to require intelligence.

A language model is a type of AI model that is trained on textual data to generate coherent and contextually relevant text. A “large” language model (LLM) refers to a language model that has been trained on an extensive dataset and has a high number of parameters, enabling them to capture complex language patterns and perform a wider range of tasks. LLMs are designed to handle a wide range of natural language processing tasks, such as text completion, translation, summarization, and even conversation. The specific parameter count required for a model to be considered a “large” language model can vary depending on context and technological advancements. However, traditionally, LLMs have millions to billions of parameters. Often, LLMs use a type of neural network called a transformer to process and understand the patterns and structures of language.

The underlying model of an LLM often consists of millions or even billions of model parameters, which are adjustable values that determine how the model behaves. The models are typically trained using a process called unsupervised learning, where they learn to predict the next word or sequence of words in a sentence based on the context provided. By doing so, LLMs develop an understanding of grammar, syntax, and semantics. As a result, LLMs are being increasingly deployed to aid in a variety of fields, including customer support, healthcare, language translation, education, software development, finance, and more.

### BRIEF DESCRIPTION OF DRAWINGS

Various examples in accordance with the present disclosure will be described with reference to the drawings, in which:

FIGS. 1A and 1B are a logical block diagram illustrating syntactically complete code completion generation for code development and caching of a plurality of additional syntactically complete code completions, according to exemplary implementations of the present disclosure.

FIGS. 2A and 2B are a logical block diagram illustrating predicted next action determination, syntactically complete code completion generation for code development at a predicted future position of the next action, and caching of a plurality of additional syntactically complete code completions, according to exemplary implementations of the present disclosure.

FIG. 3 depicts a high level overview of a software development service and environment, according to exemplary implementations of the present disclosure.

FIG. 4 depicts additional details of an example software development service, according to FIG. 3.

FIG. 5 is an example illustration of a development environment interface that includes user code, and a presented syntactically complete code completion determined based on the user code, that can be used in the software development environment of FIG. 3, in accordance with the disclosed implementations.

FIG. 6 is an example syntactically complete code completion generation process, that can be used in the software development environment of FIG. 3, according to exemplary implementations of the present disclosure.

FIGS. 7A through 7C is a logical block diagram illustrating the presentation of syntactically complete code completions and the caching of additional syntactically complete code completions over a period of time, according to exemplary implementations of the present disclosure.

FIGS. 8A through 8C is another logical block diagram illustrating the presentation of syntactically complete code completions and the caching of additional syntactically complete code completions over a period of time, according to exemplary implementations of the present disclosure.

FIG. 9 is an example predicted next action process, that can be used in the software development environment of FIG. 3, according to exemplary implementations of the present disclosure.

FIG. 10 is an example reference tracker process, that can be used in the software development environment of FIG. 3, according to exemplary implementations of the present disclosure.

FIG. 11 illustrates an example provider network environment on which some or all of the software development environment of FIG. 3 can be implemented, according to some examples.

FIG. 12 is a block diagram of an example provider network that provides a storage service and a hardware virtualization service to customers, on which some or all of the software development environment of FIG. 3 can be implemented, according to some examples.

FIG. 13 is a block diagram illustrating an example computer system that can be used in some examples of the software development environment of FIG. 3.

### DETAILED DESCRIPTION

Code completion generation is an important feature in modern integrated development environments (IDEs) and code editors, helping developers write code more efficiently by providing code completions for the next portion of code to be written. However, the logic that determines when the code completion should terminate, also known as code completion logic or End-of-Sentence (EoS) logic, can significantly impact the user experience. Likewise, the latency or perceived latency in the generation and/or presentation of code completions also has an impact on user experience. Latency in the presentation of code completions often render the code completions useless as the user has already moved past the point for which the code completion is generated and/or the user not willing to wait for the presentation of a generated code completion.

Existing code completion logic implementations often rely on simple heuristics, such as terminating the code completion at the end of each line of code. While this approach is straightforward to implement, it can lead to incomplete code completions, where the suggested code completion does not represent a valid, self-contained, syntactically complete code completion.

The disclosed implementations describe systems and methods that address the limitations of current code completion techniques, align code completion boundaries with the underlying syntax structure of the code, rather than the line structure, and proactively generate and cache syntactically complete code completions for immediate presentation, so that the latency in the generation/presentation of code completions perceived by the user is reduced or eliminated. A “syntactically complete code completion,” as used herein, refers to a code completion that is generated in accordance with the disclosed implementations that is syntactically complete when added/considered with at least a portion of the code, satisfies the grammar rules of programming language (e.g., has proper structure, correct syntax, matching parentheses, complete state) and is executable with the code without syntax errors.

For example, the disclosed implementations maintain the state of the code and the code completion, tracking whether the code completion is within a comment, literal, or binary expression, as well as the balance of parentheses, brackets, and curly braces. Optionally, the disclosed implementations may also maintain the state of the code and the code completion by further tracking whether the code completion includes a code indentation increase and/or whether the character of the code completion is an end of statement character for the programming language (e.g., semicolon (Java®, C, C++, JavaScript®, PHP®, Swift®), period (Pascal®, Ada), colon (Python®), etc.). By considering these syntactic elements like statements, blocks, and functions, the disclosed implementations can accurately determine the appropriate code completion boundaries, whether it be the end of a statement, a declaration, a block, or a function, so that the generated code completion is a syntactically complete code completion when added to the code, not just a code completion that terminates at the end of a line, like existing code completion techniques. This language-agnostic syntactic approach simplifies the implementation, reduces maintenance overhead, and enables more robust and meaningful syntactically complete code completions, leading to an improved user experience and increased developer productivity.

Still further, rather than generating only syntactically complete code completions for a current position within the code, referred to herein as a first level syntactically complete code completion, the disclosed implementations may generate and cache multiple additional levels of syntactically complete code completions so those syntactically complete code completions are immediately available for presentation to the user when the user accepts one of the currently presented syntactically complete code completions. In some examples, the disclosed implementations may also predict a next action of the user and proactively generate and cache one or more levels of syntactically complete code completions for the predicted next action so that those syntactically complete code completions are immediately available for presentation to the user if/when the user performs the predicted next action. For example, if a user has requested to open a code within a development environment, the disclosed implementations may predict a position within the code at which the user will place the cursor (predicted next action) and proactively generate syntactically complete code completion(s) at one or more levels for that predicted future position within the code so that syntactically complete code completions are immediately available for presentation to the user if/when the user places the cursor at the predicted future position.

In still further examples, the disclosed implementations may monitor the load on the computing systems used to generate syntactically complete code completions and increase or decrease the number of levels of syntactically complete code completions that are generated and/or increase or decrease the number of syntactically complete code completions generated at each level. In still other examples, a user may specify the number of levels of syntactically complete code completions that should be generated and/or the number of syntactically complete code completions that should be generated at each level. In still other examples, the number of levels of syntactically complete code completions that are generated and/or the number of syntactically complete code completions generated at each level may be dynamically adjusted based on the predicted next action of the user and/or based on the confidence that the generated syntactically complete code completions will be accepted by the user.

By adjusting the number of levels of syntactically complete code completions that are generated and/or adjusting the number of syntactically complete code completions generated at each level, the perceived latency can be increased or decreased, as is the compute capacity/cost to generate the syntactically complete code completions. For example, if low latency is of high importance, the number of levels of syntactically complete code completions may be increased so that a next syntactically complete code completion may be immediately presented numerous times in response to successive accepts of presented syntactically complete code completions. Likewise, as each presented syntactically complete code completion is accepted, additional levels of syntactically complete code completions may be generated and cached. If a sufficient number of levels of syntactically complete code completions are generated and cached, as presented syntactically complete code completions are accepted and additional levels of syntactically complete code completions generated and cached, from the perception of the user, syntactically complete code completions may continuously be immediately available for presentation and acceptance.

“Embeddings” or “code construct embeddings” as used herein, are mathematical representations that capture the semantic meaning of text data, such as a code construct, enabling efficient search, retrieval, and/or comparison. These embeddings can be stored in a memory, such as within a code repository. As discussed herein, code construct embeddings may be used to efficiently search for an identify existing segments of code (code constructs) for various purposes including, but not limited to, retrieval augmented generation (“RAG”) search, structured code search, reference determination, refactoring candidates, migration candidates, etc.

It will be appreciated that source code and documentation can be highly proprietary and so the software development service (“SDS”) discussed herein as part of a provider network will not use such content, whether developer provided or AI-generated for the developer, from one developer for purposes of assisting other developers, but rather keeps any source code, documentation, and/or learnings based on such materials (e.g., trainings, code completions, fine tuning of any of its models, etc.) within the boundaries of the owning developer's account. The SDS may also expose an application programming interface (“API”) that users/developers can use to fine-tune its artificial intelligence (“AI”) systems for their use cases and provide additional runtime context. Accordingly, there may be many slightly different copies of the AI systems of the SDS, each tuned to support a specific developer or organization based on their proprietary code and documentation.

Accordingly, disclosed are methods, apparatus, systems, and non-transitory computer-readable storage media for an SDS. The SDS can assist with a variety of software development efforts, including for complex tasks that involve multi-step reasoning or require large amounts of user-specific context, by leveraging generative AI systems such as LLMs. Generative AI systems can create new data instances as output. A new data instance means that it is generated by the model based on the model parameters and is not carried over from the model input or otherwise copied from outside the model (for example, from an index of searchable content). Example data instances include producing AI-generated code, such as a syntactically complete code completion, developing software project plans, dividing development tasks into sub-tasks or actions, troubleshooting errors, etc. The SDS acts as an intermediary between users and AI systems, enriching user prompts with additional instructions, context, and/or AI-generated code, monitoring AI system responses, and, in some cases, performing various “under-the-hood” interactions with the AI systems without requiring action by the user/developer.

In some examples, the SDS includes agent applications that formalize various software development effort workflows and their interactions with an AI system, such as an LLM. Agent applications serve as an intermediary between a user and an LLM, operating to expand user prompts, curate LLM responses, and provide the LLM with additional context often without user intervention. Additionally, various control mechanisms that regulate interactions with an LLM are introduced by way of example in the agent applications. Such control mechanisms can be used to avoid circular conversations with an LLM, keep the LLM on task, validate LLM responses, mitigate hallucinating code, etc.

In some examples a code completion agent may be utilized to monitor the state of a code development or development interface, generate syntactically complete code completions and present some or all syntactically complete code completions to a user of the development interface, for example, in-line with code in a development environment to enable the user to review, accept, or reject the presented syntactically complete code completion. Additionally, the code completion agent may generate and cache or otherwise store additional levels of syntactically complete code completions so that a next level of syntactically complete code completions can be immediately presented to the user upon acceptance of a currently presented syntactically complete code completion.

The code completion agent may interface with an AI-system, such as an LLM, providing the AI system with all or a portion of a code, context of the code, a cursor position within the code (or a predicted future cursor position within the code), etc., and request that the AI system generate a token that is a prediction of the next input expected at the cursor position. The code completion agent may include the token in the code completion and further iterate on this token to determine whether to terminate the code completion or request a predicted next token from the AI system for that code completion. When the code completion agent determines that an initial code completion (referred to herein as a first level code completion) is syntactically complete, the first level syntactically complete code completion may be sent and presented, for example, in-line to the user/developer with a development environment. In addition, the code completion agent may continue the exchange with the AI system, obtaining additional tokens, and generate one or more next level syntactically complete code completions. As discussed further below, additional levels of syntactically complete code completions generated by the code completion agent are cached or otherwise stored and each of those levels are dependent on the prior level syntactically complete code completion being accepted as part of the code. As such, if the user accepts a current level syntactically complete code completion that is presented, the accepted syntactically complete code completion is added to the code and a cached next level syntactically complete code completion is immediately presented for consideration by the user. Likewise, another level syntactically complete code completion may be generated and cached by the code completion agent so that a desired number of levels of syntactically complete code completions are maintained in the cache. In comparison, and because the cached syntactically complete code completions are dependent on acceptance of the current level syntactically complete code completion that is presented to the user, the cached syntactically complete code completions are discarded if the current level syntactically complete code completion is rejected by the user.

A “token,” as used herein, may be a character token that only includes a single character, a multi-character token that includes two or more characters, a word token that includes a single word, a multi-word token that includes two or more words, a sentence token that includes a single sentence, etc.

As used herein, a “block” or code block refers to a lexical structure of source code which is grouped together. Blocks consist of one or more declarations and statements. A programming language that permits the creation of blocks, including blocks nested within other blocks, is called a block-structured programming language. Blocks are fundamental to structured programming, where control structures are formed from blocks.

A “code construct,” as used herein, refers to a syntactic structure or element used to organize and control the flow of code in a program. Generally, a code construct refers to a building block or structural element of a programming language that serves to organize, control, or define the behavior of code. This definition covers a wide range of programming elements, which may include, but is not limited to, control structures (e.g., if-else statements, loops, switch cases), functions or methods, classes and objects, data structures, exception handling mechanisms modules or packages, variable declarations, operators and expressions, etc.

A “statement,” as used herein, refers to a syntactic unit of an imperative programming language that expresses some action to be carried out. A program written in such a language is formed by a sequence of one or more statements. A statement may have internal components (e.g. expressions). Many programming languages (e.g. Ada, Algol 60, C, Java®, Pascal®) make a distinction between statements and definitions/declarations. A definition or declaration specifies the data on which a program is to operate, while a statement specifies the actions to be taken with that data. Statements which cannot contain other statements are simple. Statements that can contain other statements are compound (block). The appearance of a statement (and indeed a program) is determined by its syntax or grammar. The meaning of a statement is determined by its semantics.

An “expression,” as used herein, refers to a syntactic entity in a programming language that may be evaluated to determine its value or fail to terminate, in which case the expression is undefined. It is a combination of one or more constants, variables, functions, and operators that the programming language interprets (according to its particular rules of precedence and of association) and computes to produce (“to return,” in a stateful environment) another value. This process, for mathematical expressions, is called evaluation. In simple settings, the resulting value is usually one of various primitive types, such as string, Boolean, or numerical (such as integer, floating-point, or complex). Expressions are often contrasted with statements—syntactic entities that have no value (an instruction).

A “declaration,” as used herein, refers to a language construct specifying identifier properties: it declares a word's (identifier's) meaning. Declarations are most commonly used for functions, variables, constants, and classes, but can also be used for other entities such as enumerations and type definitions. Beyond the name (the identifier itself) and the kind of entity (function, variable, etc.), declarations typically specify the data type (for variables and constants), or the type signature (for functions); types may also include dimensions, such as for arrays. A declaration is used to announce the existence of the entity to a compiler. This announcement is important in those strongly typed languages that require functions, variables, and constants, and their types to be specified with a declaration before use, and is used in forward declarations. The term “declaration” is frequently contrasted with the term “definition,” but meaning and usage may vary between languages.

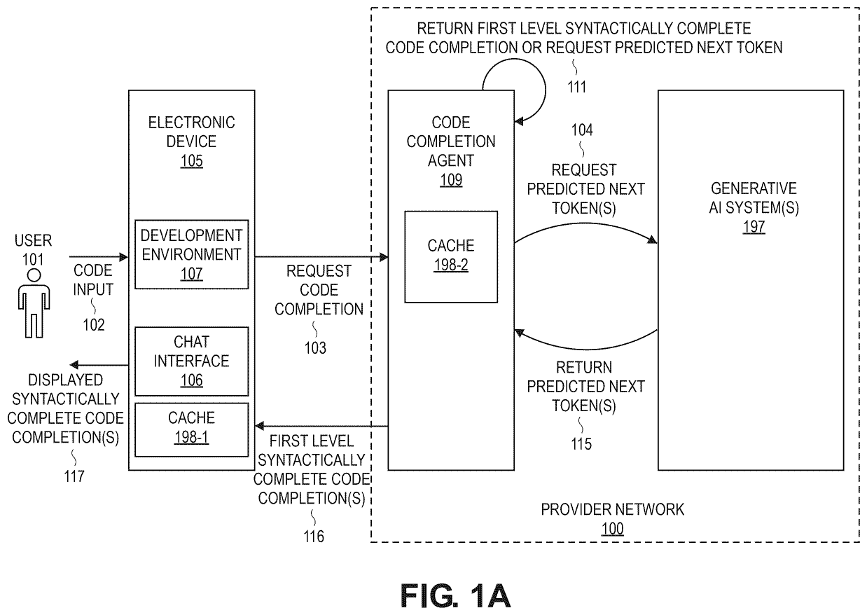

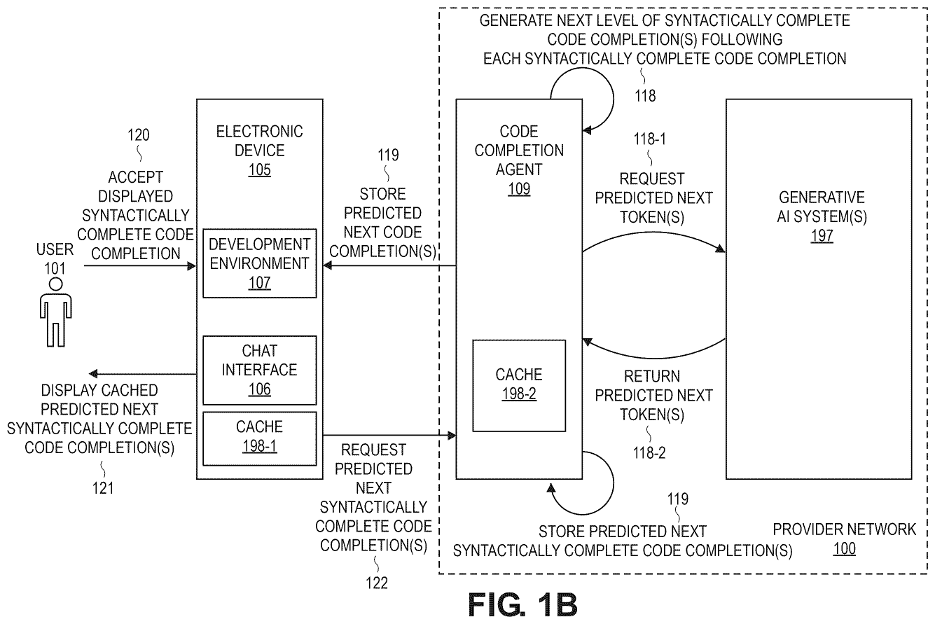

FIGS. 1A and 1B are logical block diagrams illustrating syntactically complete code completion generation for code development and caching of a plurality of additional syntactically complete code completions, according to some implementations. As illustrated, a user 101, such as a developer, through interaction with an electronic device 105, such as through a development environment 107 and/or chat interface 106 may communicate with a code completion agent 109 of a provider network 100 and obtain one or more levels of syntactically complete code completions that may be presented in-line in the development environment and/or maintained in a cache 198-1 of the electronic device 105 and/or in the cache 198-2 of the provider network 100 for immediate or almost immediate presentation in-line as a next syntactically complete code completion in response to acceptance of a presented syntactically complete code completion.

For example, the development environment 107 may make use of the code completion agent 109 when a code input is received at the development environment 107. As discussed in detail below, the code completion agent 109 may proactively generate one or more levels of syntactically complete code completion(s), with one or more syntactically complete code completion(s) at each level before providing the one or more of the levels of syntactically complete code completions to the client device 105 for presentation as displayed syntactically complete code completion(s) 117 and/or caching as next level syntactically complete code completions. By proactively generating multiple levels of syntactically complete code completions, latency experienced by the user 101 can be reduced or eliminated. For example, multiple requests 104 to a generative AI system 197 for tokens and determination of whether to terminate and complete a code completion as a syntactically complete code completion, or request another token, may result in latency, but such apparent latency to the user will be at or near 0 for syntactically complete code completions while still ensuring thorough validation that the syntactically complete code completions presented as syntactically complete code completions 117 are still valid (in light of potentially changing context, such as other code input 102) before a syntactically complete code completion 117 is displayed.

Other performance improvements to the use and implementation of the disclosed implementations include, but are not limited to, maintaining code state and code completion state by tracking whether the code completion is within a comment, literal, binary expression, and whether there is a balance of parentheses, brackets, and curly braces. Optionally, the disclosed implementations may further maintain code state and code completion state by tracking whether the code completion includes a code indentation increase and/or whether a character of the code completion is an end of statement character. Additionally, the disclosed implementations can handle syntactically complete code completions that are statement/declaration completions, block completions, function completions, expression completions, etc., in a programming language-agnostic manner, without the need for complex trigger detection logic. Still further, disclosed implementations provide a simplification of processing to determine when to terminate and send a syntactically complete code completion for display, or for storage as a next level syntactically complete code completion, along with an increase in the quality, accuracy, and completeness of displayed syntactically complete code completions.

As illustrated, the code completion agent 109 may obtain a current code in which code input 102 may be submitted by a user 101 as part of a request for a syntactically complete code completion 103, receive predicted next tokens 115 that are added to a first level code completion, iterate over all characters of the received token(s), and maintain a state of the code and/or first level code completion at the current position or end point of the first level code completion. For example, based on the current tokens of the code prior to the current position in the code (e.g., position of the cursor as presented on the electronic device 105 to the user 101) and the current tokens of the first level code completion, the code completion agent 109 may determine if the current position at the end position of the first level code completion is within a comment (single-line #, // or multi-line /*, or ′″) or within a literal (bounded by ,′, ,′″, ∨) . Characters that are within a comment or literal are not interpreted by the code completion agent when determining if the code completion should be terminated. As such, if it is determined that the current position at the end of the first level code completion is within a comment or a literal 111, the code completion agent may process the next character of the current token or submit another request 104 to the generative AI system for a predicted next token, and continue processing characters of tokens to determine if the first level code completion should be terminated and returned as a first level syntactically complete code completion 116.

If it is determined that the current position at the end of the first level code completion is not within a comment or literal, the code completion agent 109 may further determine whether the balance of opening parentheses, opening brackets, and opening curly braces and corresponding closing parentheses, closing brackets, and closing curly braces characters at the end position is equal to zero. If the balance of parentheses, brackets, and curly braces characters is not zero, the code completion agent 109 may process the next character of the token or request 111 a predicted next token 104 from the generative AI System 197. If the balance of parentheses, brackets, and curly braces characters is zero, the code completion agent 109 may determine if the current position is within a binary expression as indicated by the presence of an operator character such as ⋅, =, !, >, <, −, +, *, ÷, %, ?, :, ∧, ∨, ¿, in the previous or next character, with respect to the current position within the code completion. As discussed further below, because determination as to whether the current position is within a binary expression considers characters beyond the end position of the code completion, a look-ahead buffer or sliding window of a defined number of tokens (e.g., five tokens past the current end position of the code completion) may be maintained and considered. If it is determined that the end position of the first level code completion is within a binary expression, the code completion agent will process the next character of the token or request a predicted next token 104.

Optionally, if it is determined that the current position at the end of the first level code completion is not within a comment, not within a literal, that the balance of parentheses, brackets, and curly braces characters is zero, and that the current position of the first level code completion is not within a binary expression, the code completion agent 109 may further determine if the current position at the end of the first level code completion includes a code indentation increase in the code. Such determination may aid in identifying an end of a first level code completion in programming languages that utilize changes in code indentations to indicate end of statements, such as Python® and YAML. If it is determined that the end position of the first level code completion includes an increase in a code indentation, the first level code completion agent will process the next character of the token or request a predicted next token 104.

Still further, if it is determined that the current position at the end of the first level code completion is not within a comment, not within a literal, that the balance of parentheses, brackets, and curly braces characters is zero, that the current position of the first level code completion is not within a binary expression, and optionally that the end position of the code completion does not include an increase in the code indentation, the code completion agent 109 may further optionally determine if the character at the current position at the end of the first level code completion includes an end of statement character for the programming language of the code being processed (e.g., semicolon (Java®, C, C++, JavaScript®, PHP, Swift®), period (Pascal®, Ada), colon (Python®)). If it is determined that the character at the end position of the first level code completion does not include an end of statement character, the code completion agent will process a next character of the code or request a predicted next token 104.

By maintaining state of the code completion, the code completion agent 109 can quickly determine if a code completion should be terminated to form a syntactically complete code completion or if a predicted next token should be obtained from the generative AI system 197 and added to the code completion. If it is determined that the end position of the code completion is not a comment or a literal, the balance of opening parentheses, opening brackets, and opening curly braces and corresponding closing parentheses, closing brackets, and closing curly braces characters is zero, the end position is not within a binary expression, and optionally if the next character is a blank character (\n, \r, \t,) , an end of statement character (;), or whether there is no increase in code indentation, the code completion agent 109 will include the addition of tokens to the first level code completion, complete the first level code completion, and return the first level code completion to the development environment as a syntactically complete code completion for presentation as a syntactically complete code completion 117.

Turning to FIG. 1B, upon completion of the first level syntactically complete code completion, the code completion agent 109 may continue the exchange with the generative AI system 197, requesting predicted next tokens 118-1, receiving predicted next tokens 118-2, and generating one or more next level syntactically complete code completions 118. As discussed, each next level syntactically complete code completion is generated based on tokens produced by the AI systems 197 assuming the prior generated tokens, which are included in prior levels of syntactically complete code completions, have been accepted and are part of the code and code state.

Similar to generation of the first level syntactically complete code completion, the code completion agent maintains the state of each next level code completion and can quickly determine if a code completion should be terminated to generate a syntactically complete code completion or if a predicted next token should be obtained from the generative AI system 197 and added to the code completion. If it is determined that the end position of the next level code completion is any one or more of within a comment or a literal, that the balance of opening parentheses, opening brackets, and opening curly braces and corresponding closing parentheses, closing brackets, and closing curly braces characters is not zero, that the end position is within a binary expression, and optionally if the next character is a blank character (\n, \r, \t,) , an end of statement character (;), or whether there is an increase in code indentation, the code completion agent 109 will continue to iterate on the token or request a next token for inclusion in the code completion, as discussed herein. Comparatively, if it is determined that the end position of the code completion is not a comment or a literal, the balance of opening parentheses, opening brackets, and opening curly braces and corresponding closing parentheses, closing brackets, and closing curly braces characters is zero, the end position is not within a binary expression, and optionally if the next character is a blank character (\n, \r, \t,) , an end of statement character (;), or whether there is no increase in code indentation, the code completion agent 109 will include the addition of tokens to the current level code completion, complete generation of the current level code completion to produce a current level syntactically complete code completion, and store the current level syntactically complete code completion in the cache 198-2 of the code completion agent and/or send 119 the current level syntactically complete code completion for storage in the cache 198-1 of the electronic device. The code completion agent may generate and store multiple levels of syntactically complete code completions, each level dependent upon acceptance of the prior level syntactically complete code completion(s).

Upon acceptance of a displayed syntactically complete code completion 120, rather than the code completion agent having to generate and send for display a new syntactically complete code completion, a next level syntactically complete code completion that has already been generated and stored in the cache 198-2 of the code completion agent 109 or the cache 198-1 of the electronic device 105 may be selected and presented in the development environment as the next syntactically complete code completion 121. By pre-generating and caching the next level syntactically complete code completions so that a next syntactically complete code completion can be selected and presented upon acceptance of a prior syntactically complete code completion, the latency or perceived latency by the user is reduced if not completely eliminated.

In some implementations, the development environment 107, upon acceptance of a displayed syntactically complete code completion, may request a next syntactically complete code completion. In such an example, the code completion agent 109, rather than generating a next syntactically complete code completion, may immediately select and send the cached next level syntactically complete code completion for presentation as a suggested syntactically complete code completion. In other examples, as each level of syntactically complete code completions is generated, the syntactically complete code completions may be sent by the code completion agent 109 for storage in a cache 198-1 that is local to the development environment 107, whether that be part of the provider network (e.g., the electronic device 105 is a virtual machine) or remote from the provider network (e.g., the electronic device is physically separate from the provider network). In such an example, the development environment 107, upon a user accepting a displayed syntactically complete code completion, rather than requesting another syntactically complete code completion, may immediately select and display as a syntactically complete code completion the next level syntactically complete code completion maintained in the cache 198-1. In addition, the development environment 107 may provide a notification to the code completion agent 109 informing the code completion agent that the displayed syntactically complete code completion has been accepted and the next syntactically complete code completion maintained in the cache 198-1 has been retrieved and presented. In such an instance and as discussed herein, upon such notification and/or upon the code completion agent 109 retrieving and sending a next level syntactically complete code completion from the cache 198-2, the code completion agent may continue its exchange with the AI systems 197 and generate another level syntactically complete code completion to add to the cache.

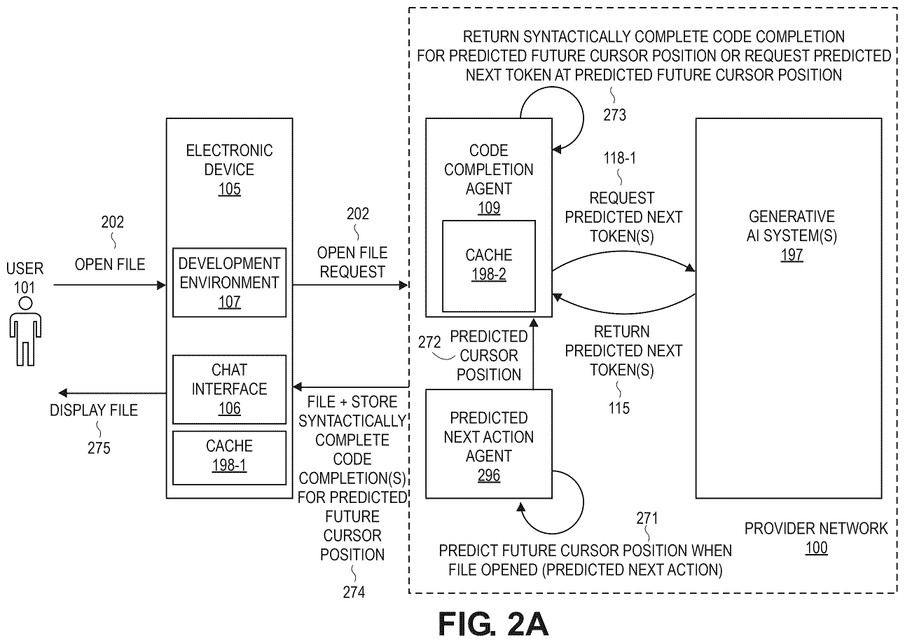

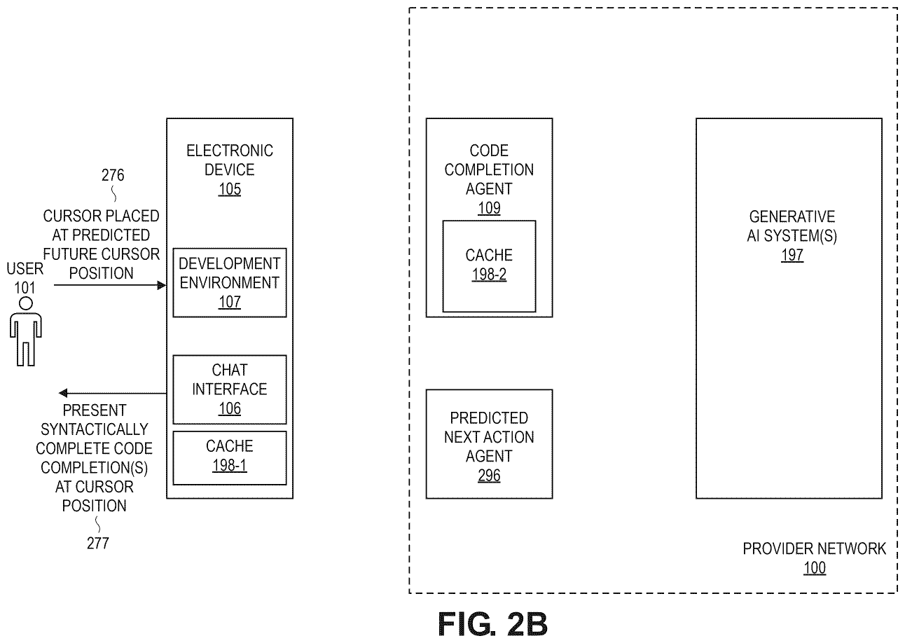

FIGS. 2A and 2B are a logical block diagram illustrating predicted next action determination, syntactically complete code completion generation for code development at a predicted future position of the next action, and caching of a plurality of additional syntactically complete code completions, according to exemplary implementations of the present disclosure.

As discussed further below, in some implementations, a predicted next action agent 296 may predict a next action or series of next actions by a user 101 using the client device 105 and operating within the development environment 107 or the chat interface 106. For example, the predicted next action agent may receive development environment history for the user, such as a log file, indicating actions taken by the user in the log file (e.g., file opens, cursor positions, edits, saves, etc.) and predict a next action of the user. Such predictions may be used to guide the code completion agent in generating syntactically complete code completions and/or the number of levels of syntactically complete code completions to generate.

In the example illustrated in FIGS. 2A and 2B, when the user 101 submits an open file request 202, the development environment 107 may send the open file request 202 and/or a log file that includes the user history with the development environment to the provider network 100 to access and provide the requested file. The predicted next action agent 296 may process the user history, which includes the most recent action of an open file request, and predict one or more next actions of the user. For example, the predicted next action agent 296 may predict a future cursor position at which the user will place the cursor when the requested file is opened 271. The predicted future cursor position may be provided 272 by the predicted next action agent 296 to the code completion agent 109. The code completion agent, upon receipt of the predicted future cursor position, may obtain portions of the code that is before and/or after the predicted future cursor position, determine context for the code at that predicted future cursor position and, similar to the discussion above, complete one or more exchanges with the generative AI system 197, requesting token(s) 118-1, receiving returned predicted next tokens 115, and generating one or more levels of syntactically complete code completions at the predicted future cursor position 273. As each syntactically complete code completion is generated based on the predicted next action, the syntactically complete code completion is stored in the cache 198-1/198-2. If the user performs the predicted action, such as placement of the cursor at the predicted future cursor position, the pre-generated syntactically complete code completion that is maintained in the cache may be immediately presented to the user as soon as the predicted action is performed.

In the illustrated example, the provider network returns, to the development environment, the syntactically complete code completion(s) generated assuming the predicted action (placement of the cursor at the predicted future cursor position) 274. The file may be opened and displayed 275 to the user 101 through the development environment 107 and the syntactically complete code completion(s) stored in the cache 198-1 of the electronic device 105.

Turning to FIG. 2B, in this example, the user 101 performs the predicted action and places the cursor the predicted future cursor position 276. Upon detection of the predicted next action being performed by the user, the syntactically complete code completion that was pre-generated and stored in the cache may be presented to the user at the cursor position 277 such that the latency or perceived latency by the user is reduced or completely eliminated.

While the example discussed with respect to FIGS. 2A and 2B describe the predicted action as the predicted future cursor position at which a user will place a cursor after accessing a file, it will be appreciated that any of a variety of predicted next actions may be determined by the predicted next action agent 296 and used by the code completion agent 109 to generate one or more levels of syntactically complete code completions. In some implementations, the predicted next action agent may predict the likelihood or probability that the user will accept a currently presented syntactically complete code completion, whether the user will move to a next location within the code, whether the user will make an edit to the code, etc. The code completion agent may utilize each predicted next action to generate one or more levels of syntactically complete code completions or to determine whether to complete a next level of syntactically complete code completions. For example, if the predicted next action is that the user will reject the presented syntactically complete code completion, the code completion agent may refrain from generating a next level syntactically complete code completion. In comparison, if the predicted next action is an acceptance of the presented syntactically complete code completion, the code completion agent may proceed with generating a next level of syntactically complete code completion(s), assuming that the currently displayed syntactically complete code completion is accepted. In still other examples, the predicted next action may be that the user will move the cursor to a new position within the code. In such an example, the code completion agent may generate a first level syntactically complete code completion at that predicted future cursor position so that the first level syntactically complete code completion is ready and available for immediate display if/when the user does perform the predicted next action.

In some examples, the predicted next action agent 296 may generate one or more predicted next actions and/or indicate a probability score for each predicted next action, the probability score indicative of a confidence level that the predicted next action will actually be performed by the user. For example, the code completion agent may predict that the user will either position the cursor at the beginning of the file or at a particular location within the file. In such examples, the code completion agent may generate one or more levels of syntactically complete code completions for each of the predicted next actions and store those syntactically complete code completions in a cache. If the user actually performs one of the predicted next actions, the pre-generated syntactically complete code completion for that predicted next action may be retrieved from the cache and displayed to the user as soon as the user performs the respective predicted next action. In still further examples, the code completion agent may utilize the probability scores to decide whether to generate syntactically complete code completions for a predicted next action and/or to determine how many levels of syntactically complete code completions to generate for a predicted next action. For example, a first threshold may be defined and first level syntactically complete code completions only generated for predicted next actions with a probability score above the first threshold. Likewise, a second threshold, which may be equal to or higher than the first threshold may be defined and additional levels of syntactically complete code completions (e.g., second level, third level) may only be generated for those predicted next actions that satisfy the second threshold.

As discussed further below, while the above examples discuss the use of the code completion agent 109 to generate syntactically complete code completions that are terminated and returned to an electronic device 105 for display as syntactically complete code completions 117, or stored as next level syntactically complete code completions, and/or the predication of next actions to guide generation of syntactically complete code completions, the disclosed implementations may also be used for reference tracking within code, for example to define portions of code that may then be compared with, for example, open source code, and a suggestion made as to whether that portion of code should be considered for referencing. Such reference determination may be made, for example, as syntactically complete code completions are generated in accordance with the disclosed implementations.

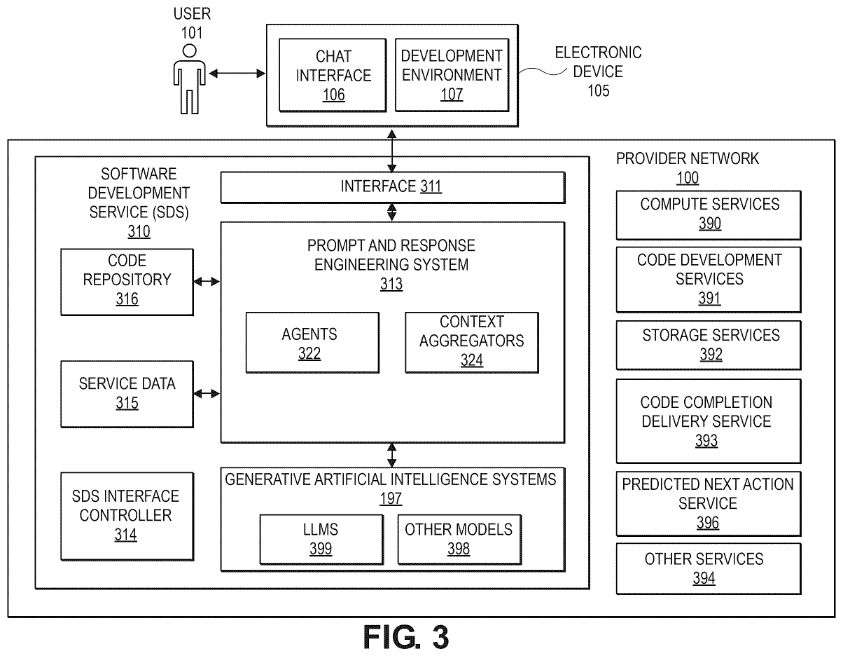

FIG. 3 depicts a high level overview of an SDS 310 and environment according to some examples. An SDS 310 acts as an intermediary that interfaces with generative AI systems 197, such as language models, on behalf of clients. Language models probabilistically generate natural language (e.g., the word “said” is more likely to appear after the word “he” than after the word “dolphin”). LLMs 399 are one type of language model developed with a neural network architecture often including millions or even billions of model parameters, which are trained using datasets of documents that determine how the model behaves. The size of such datasets can include thousands, millions, or even more documents. Exemplary LLMs include Amazon's Titan, Anthropic's Claude 3.5 Sonnet, etc.

A language model is a type of artificial intelligence (AI) model that is trained on textual data to generate coherent and contextually relevant text. A “large” language model refers to a language model that has been trained on a broad spectrum of generalized, unlabeled data and has a high number of parameters, enabling them to capture complex language patterns and perform a wide range of tasks such as understanding language, generating text and images, and conversing in natural language. Large language models are designed to handle a wide range of natural language processing tasks, such as text completion, translation, summarization, and even conversation. The specific parameter count required for a model to be considered a “large” language model can vary depending on context and technological advancements. However, traditionally, large language models have millions to billions of parameters.

As an intermediary, the SDS 310 can manage user 101 interactions with AI systems 197. For example, the SDS 310 can expand or produce prompts before submitting them to an LLM 399 and can curate LLM responses. Expanding or producing prompts can provide the LLM 399 with additional information relevant to a particular task, including by adding additional context about the nature of the task and by adding context-specific details. With prompt expansion, the SDS 310 can improve the quality of LLM responses. For example, when a developer is writing code, the SDS 310 may tokenize the code inputs, for example by producing a token for each word input by the developer and/or combining one or more tokens to produce a prompt to an LLM 399 requesting that the LLM produce a predicted next token(s) that is predicted to be a next piece of code in the code development by the developer. Prompt expansion may include providing other context and/or portions of the developed code as part of the prompt to guide the LLM 399 in producing the predicted next token(s), thereby increasing the accuracy in the AI system. The SDS 310, upon receipt of a predicted next token, in accordance with the disclosed implementations, may add the predicted next token to a code completion and iterate over the characters of that token to decide whether to terminate the code completion and return the code completion as a syntactically complete code completion for presentation or storage, or request a predicted next token from the AI system. This process of requesting a predicted next token, adding the token to the code completion, and iterating over the characters of the token to determine whether to terminate and return the code completion as a syntactically complete code completion may continue until the SDS 310 determines that all requirements for terminating the code completion are satisfied. For example, as discussed herein, the requirements for completing the code completion to form a syntactically complete code completion may be that the state of the code, including the code completion, is such that the current position (end of code completion) is outside of a comment or a literal, the balance of opening parentheses, opening brackets, and opening curly braces and corresponding closing parentheses, closing brackets, and closing curly braces characters is zero, and the current position is outside of a binary expression.

One common environment for an SDS 310 is a provider network 100. A provider network 100 (or, “cloud” provider network) provides users 101 with the ability to use one or more of a variety of types of computing-related resources such as compute resources (e.g., executing virtual machine (“VM”) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (“CDNs”), Domain Name Service (“DNS”)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users 101 (or “customers”) of provider networks 100 can use one or more user accounts that are associated with a customer account, though these terms can be used somewhat interchangeably depending upon the context of use. Users 101 can interact with a provider network 100 via one or more interface(s), such as through use of API calls, via a console implemented as a website or application, through a development environment interface 107, a chat interface 106, etc.

An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another.

For example, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

Cloud provider networks often provide access to computing resources via a defined set of regions, availability zones, and/or other defined physical locations where a cloud provider network clusters data centers. In many cases, each region represents a geographic area (e.g., a U.S. East region, a U.S. West region, an Asia Pacific region, and the like) that is physically separate from other regions, where each region can include two or more availability zones connected to one another via a private high-speed network, e.g., a fiber communication connection. An availability zone (also known as an availability domain, or simply a “zone”) refers to an isolated failure domain including one or more data center facilities with separate power, separate networking, and separate cooling from those in another availability zone. Preferably, availability zones within a region are positioned far enough away from one another that the same natural disaster should not take more than one availability zone offline at the same time, but close enough together to meet a latency requirement for intra-region communications. The data centers house physical computing devices (e.g., suitable types of servers) that host the bare metal and virtualized resources (e.g., compute, networking, & storage) on which cloud services and customer workloads run.

Furthermore, regions of a cloud provider network are connected to a global “backbone” network which includes private networking infrastructure (e.g., fiber connections controlled by the cloud provider) connecting each region to at least one other region. This infrastructure design enables users of a cloud provider network to design their applications to run in multiple physical availability zones and/or multiple regions to achieve greater fault-tolerance and availability. For example, because the various regions and physical availability zones of a cloud provider network are connected to each other with fast, low-latency networking, users can architect applications that automatically failover between regions and physical availability zones with minimal or no interruption to users of the applications should an outage or impairment occur in any particular region.

To provide these and other computing resource services, provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code-typically without the user having any control of or knowledge of the underlying compute instance(s) involved.

As described herein, one type of service that a provider network 100 may provide may be referred to as a “managed compute service” that executes code or provides computing resources for its users in a managed configuration. Examples of managed compute services include, for example, an on-demand code execution service, a hardware virtualization service, a container service, or the like.

An on-demand code execution service (referred to in various examples as a function compute service, functions service, cloud functions service, functions as a service, or serverless computing service) can enable users 101 of the provider network 100 to execute their code on cloud resources without having to select or manage the underlying hardware resources used to execute the code. For example, a user 101 can use an on-demand code execution service by uploading their code and use one or more APIs to request that the service identify, provision, and manage any resources required to run the code. Thus, in various examples, a “serverless” function can include code provided by a user or other entity - such as the provider network itself—that can be executed on demand. Serverless functions can be maintained within the provider network 100 by an on-demand code execution service and can be associated with a particular user or account or can be generally accessible to multiple users/accounts. A serverless function can be associated with a Uniform Resource Locator (“URL”), Uniform Resource Identifier (“URI”), or other reference, which can be used to invoke the serverless function. A serverless function can be executed by a compute resource, such as a virtual machine, container, etc., when triggered or invoked. In some examples, a serverless function can be invoked through an API call or a specially formatted HyperText Transport Protocol (“HTTP”) request message. Accordingly, users can define serverless functions that can be executed on demand, without requiring the user to maintain dedicated infrastructure to execute the serverless function. Instead, the serverless functions can be executed on demand using resources maintained by the provider network 100. In some examples, these resources can be maintained in a “ready” state (e.g., having a pre-initialized runtime environment configured to execute the serverless functions), allowing the serverless functions to be executed in real-time or near real-time.

A hardware virtualization service (referred to in various implementations as an elastic compute service, a virtual machines service, a computing cloud service, a compute engine, or a cloud compute service) can enable users 101 of the provider network 100 to provision and manage compute resources such as virtual machine instances. Virtual machine technology can use one physical server to run the equivalent of many servers (each of which is called a virtual machine), for example using a hypervisor, which can run at least partly on an offload card of the server (e.g., a card connected via PCI or PCIe to the physical CPUs) and other components of the virtualization host can be used for some virtualization management components. Such an offload card of the host can include one or more CPUs that are not available to user instances, but rather are dedicated to instance management tasks such as virtual machine management (e.g., a hypervisor), input/output virtualization to network-attached storage volumes, local migration management tasks, instance health monitoring, and the like). Virtual machines are commonly referred to as compute instances or simply “instances.” As used herein, provisioning a virtual compute instance generally includes reserving resources (e.g., computational and memory resources) of an underlying physical compute instance for the client (e.g., from a pool of available physical compute instances and other resources), installing or launching required software (e.g., an operating system), and making the virtual compute instance available to the client for performing tasks specified by the client.

Another type of managed compute service can be a container service, such as a container orchestration and management service (referred to in various implementations as a container service, cloud container service, container engine, or container cloud service) that allows users of the cloud provider network to instantiate and manage containers. In some examples the container service can be a Kubernetes-based container orchestration and management service (referred to in various implementations as a container service for Kubernetes, Azure Kubernetes service, IBM cloud Kubernetes service, Kubernetes engine, or container engine for Kubernetes). A container, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine. In contrast, virtual machines are an abstraction of the hardware layer (meaning that each virtual machine simulates a physical machine that can run software). While multiple virtual machines can run on one physical machine, each virtual machine typically has its own copy of an operating system, as well as the applications and their related files, libraries, and dependencies. Some containers can be run on instances that are running a container agent, and some containers can be run on bare-metal servers, or on an offload card of a server.

A virtual private cloud (“VPC”) (also referred to as a virtual network (“VNet”), virtual private network, or virtual cloud network, in various implementations) is a custom-defined, virtual network within another network, such as a cloud provider network. A VPC can be defined by at least its address space, internal structure (e.g., the computing resources that comprise the VPC, security groups), and transit paths, and is logically isolated from other virtual networks in the cloud. A VPC can span all of the availability zones in a particular region.

A VPC can provide the foundational network layer for a cloud service, for example a compute cloud or an edge cloud, or for a customer application or workload that runs on the cloud. A VPC can be dedicated to a particular customer account (or set of related customer accounts, such as different customer accounts belonging to the same business organization). Customers can launch resources, such as compute instances, into their VPC(s). When creating a VPC, a customer can specify a range of IP addresses for the VPC in the form of a Classless Inter-Domain Routing (CIDR) block. After creating a VPC, a customer can add one or more subnets in each availability zone or edge location associated with its region.

The SDS 310 can assist users 101 with various software development tasks. Example software development tasks include development of software project plans, subdividing a software development task into steps, troubleshooting software errors, transforming code from an old or out of date version to a current version of the code (e.g., Java 8® to Java 17®), transforming code from one language or platform to another (e.g., . net® to Linux®), producing AI-generated code for the user, referred to herein as syntactically complete code completion suggestions or syntactically complete code completions, etc. Strung end-to-end, these tasks can represent a large portion of an overall software development effort, from planning to implementation and troubleshooting. Note that as used herein, a software system can refer to an individual program or to a collection of programs, context about the program(s) such as their operating environment and/or structure on which they are executed or distributed (e.g., cloud-level resources), mappings of communications or data flows between the programs (if applicable), etc.

As illustrated, the SDS 310 includes an interface 311, a prompt and response engineering system 313 that includes agents 322 and context aggregators 324, service data 315, and LLMs 399. The interface 311, typically an API, provides different entry points for clients to interact, via the SDS 310, with an LLM 399 and/or other generative AI systems 197, such as other models 398. A user 101 interacts with an SDS 310 via an electronic device 105. The electronic device 105 can display one or both of a chat-based interface 106 and a development environment interface 107. Interfaces 106, 107 send and receive data via the interface 311 of the SDS 310. The chat-based interface 106 can be part of a graphical user interface providing a “chat” type interface commonly associated with LLMs in which users can type text and receive responses.

The development environment 107 can provide the display of graphical architecture diagrams of software systems, text based code, etc., and allow users 101 to make modifications to their software systems. For example, the development environment 107 can use different icons to represent different resources (or clusters of similar resources such as autoscaling groups) of an application, and can connect these icons via lines to show network flows between the different resources. When using the development environment for code development, the development environment may allow interaction with the SDS 310 and presentation of syntactically complete code completions within the code (in-line) developed by the user 101 so that the user has the option to accept or reject the suggested syntactically complete code completion. The SDS 310 can maintain a model of the application architecture visualized in the development environment that it can translate into infrastructure as code (“IaC”) definitions, and can also translate IaC definitions into visual architecture diagrams.

The interface 311 can also provide a more programmatic entry point for other applications or services such as an issue management service (also sometimes referred to as issue tracking service), a logging service of the provider network, or the application displaying the interfaces 106, 107 (e.g., a software development environment or issue management application executed by the electronic device 105). API calls via these type entry points can include, like the chat-based interface, free-form text (e.g., bug descriptions or change requests from an issue tracking system, error messages from the logging service, etc.) but further include additional contextual parameters available to the application or application environment issuing the call (e.g., an identification of the code repository associated with a particular software change request, an identification of the cloud-hosted instance generating a log entry, etc.).

Generally speaking, the SDS interface 311 can provide for interactions with various clients, including human users such as user 101 via interfaces 106, 107, and with other applications such as software development environments, software management systems, issue tracking systems, etc. These application-based clients typically interact with the SDS API via calls having a more structured set of parameters (e.g., accepting a structured format file that includes identifications of various data sources) as compared to the freeform text found in calls from the chat-based interface 106, for example.

The SDS 310 can support multi-tenancy, allowing multiple clients to connect and interact with LLMs 399. Each client can have one or more sessions with the SDS 310, the sessions corresponding to sessions with an LLM 399. To do so, the SDS 310 can track, for a given session, the last N prompts sent to, and responses received from the LLM in a memory such as in service data 315. The memory can be implemented as a moving window or circular buffer: as new prompts are sent and responses received, the SDS 310 deletes or overwrites the oldest entries. For a given session, the prompt and response engineering system 313 may embed all or a portion of the session memory in prompts submitted to the LLM 399 by any of the agents 322. For example, if a session includes session history X and a new prompt P, the prompt and response engineering system 313 can submit concatenate P to X or to the most M most recent prompts and responses (where M<N) and submit the result of the concatenation to the LLM 399.

The SDS 310 can assign a session identifier to new sessions, allowing clients to pause and resume sessions. By referencing a session identifier upon connecting to the SDS 310, a client can return to an existing session. The SDS 310 can permit access to sessions based on a permissions policy associated with a principal account credential provided in establishing a connection to connect to the SDS 310. The credential may be associated with a user 101 or group of an organization. The permissions policy can permit sharing of a session across different entities within the organization. For example, a first client may initiate a first session with the SDS 310 and receive a session identifier X. Later, a second client may resume the first session with the SDS 310 by providing the session identifier X, provided the credential provided when the second client established the connection to the SDS 310 is permitted to do so.

The prompt and response engineering system 313 can also monitor client text inputs over a session for certain session-management instructions. Such session-management instructions can be associated with various session-level operations. One example session-level operation is SESSION_RESET to reset a session, clear the memory associated with that session, and reset the associated session(s) with LLMs 399. Another example session-level operation is SESSION_CLOSE to close a session with the SDS 310 and any associated session(s) with LLMs 399.

The prompt and response engineering system 313 includes agents 322 and context aggregators 324. Agents 322 include various task-specific agents as well as other general agents that support SDS interactions with an LLM 399. Task-specific agents formalize various software development effort workflows, operating to expand user prompts, curate LLM responses, provide the LLM 399 with additional context often without user intervention, etc. Context aggregators 324 retrieve additional data that agents 322 can use to expand or create prompts or to otherwise provide to an LLM 399 as context to improve the relevance of LLM responses. The context aggregators 324 can retrieve the additional data from other cloud-based services, such as compute services 390, code development services 391, storage services 392, code completion delivery service 393, predicted next actions service 396, other services 394, etc.

As discussed further below, in some implementations, the SDS 310 may implement various features or services for writing code for different systems, applications, or devices, providing features to recommend, identify, review, build, and deploy code. For example, the SDS 310 may implement a code development service 391. The code development service 391 may offer various code entry tools (e.g., text, diagram/graphics based application development) to specify, invoke, or otherwise write (or cause to be written) code for different hardware or software applications.

SDS 310 may implement code completion delivery service 393 which may implement various computing resources to host and/or implement syntactically complete code completions in conjunction with the code completion agent, discussed below, in a scalable fashion to deliver on-demand syntactically complete code completions across large numbers of clients using high-powered machine learning models for generation of high-quality syntactically complete code completions. For example, code completion delivery service 393 may implement workload balancing and request management features to handle and return syntactically complete code completions in a timely manner to provide real-time or near real-time syntactically complete code completions with little or no apparent latency.

To avoid making development environments wait on multiple syntactically complete code completions to be sent in one communication, in some implementations, the code completion delivery service 393 may implement pagination features for syntactically complete code completions to allow multiple syntactically complete code completions to be delivered from hosts or other computing resources implementing and generating syntactically complete code completions to recipient development environments, such as a development environment on a client device 105. In this way, syntactically complete code completions that are valid may be made and presented, and then updated as more are received. Such techniques offer a simulated streaming experience, without actually requiring bi-directional streaming to be supported at the development environments. In this way, the benefits of fast delivery and update of syntactically complete code completions can be provided without introducing additional requirements onto development environments, which may not necessarily be maintained by the provider network 100.

To implement pagination, syntactically complete code completions may be stored in the SDS 310 as they are generated and can then be returned over multiple exchanges by utilizing a pagination token that accompanies the requests for syntactically complete code completions in order to allow for the additional syntactically complete code completions to be retrieved from storage and sent back to a development environment.

In various implementations, an agent, such as a code completion agent 109, may generate syntactically complete code completions based on text input in a development environment 107, chat interface 106, etc. (e.g., utilizing a plug-in or other connection which may provide real-time or near real-time analysis and suggestion of code as the code is entered into the development environment 107), as discussed in detail below. The code completion agent 109 may use generative AI-models or systems 197, such as Generative Pre-trained Transformer (GPT) trained to generate syntactically complete code completions, a large language model (“LLM”), and/or other AI system.

SDS 310 may implement predicted next action service 396 which may utilize various computing resources to host and/or implement predicted next actions in conjunction with the predicted next action agent, discussed below, in a scalable fashion to deliver on-demand predicted next actions across large numbers of clients using high-powered machine learning models for high-quality predicted next action results. For example, predicted next actions service 396 may implement workload balancing and request management features to handle and return predicted next actions in a timely manner so that determinations may be made by the code completion agents 109 as to whether to generate an additional level of syntactically complete code completions in a sequence of syntactically complete code completions, and/or generate syntactically complete code completions at predicted locations within the code, as discussed herein.

In various implementations, an agent, such as a predicted next action agent 296, may generate predicted next actions based on text input received in the form of a development environment history of a user, such as a development environment history log file (e.g., utilizing a plug-in or other connection which may provide real-time or near real-time actions as the actions are performed by the user in the development environment 107). The predicted next action agent 296 may use generative AI-models or systems 197, such as a GPT trained to generate predicted next actions, an LLM, and/or other AI system(s).

The SDS 310 may implement (or have access to) code repositories 316. Code repositories 316 may store various code files, objects, embeddings, and/or other code that may be interacted with by various other features of the SDS 310 (e.g., development environment 107 to write, build, compile, and/or test code). Code repositories 316 may implement various versions and/or other access controls to track and/or maintain consistent versions of collections of code for various development projects, in some implementations. In some implementations, code repositories 316 may be stored or implemented external to provider network 100 (e.g., hosted in private networks or other locations). Service data 315 can include data such as prompt templates, response definitions, user preferences, session state data, etc.

Generative AI systems 197 include LLMs 399 and other models 398, such as generative pre-trained transformers (“GPT”). Generative models, such as LLMs are artificial intelligence systems designed to understand and generate human-like text. These models are trained using machine learning techniques, typically on vast amounts of text data from the internet, books, articles, and other sources.

Generative models are often trained on a large corpus of data for a specific task. In the case of generating code recommendations, the corpus of code, such as from the code repository 316 and/or other sources can be comprised of code repositories or code constructs from a variety of sources. Depending on the source or owner, the code may be subject to certain licenses which may need to be attributed in any usage or reproduction. Since a generative model can sometimes reproduce verbatim, or close to verbatim, matches to the training data, metadata for identifying the origin of such matches (including project name, license, and a link to the repository) may also be provided along with the suggestion (referred to herein as “references” or “referencing”). Syntactically complete code completion metadata (not illustrated) may provide the ability to provide metadata for syntactically complete code completions that may be provided.

Often, LLMs 399 use a type of neural network called a transformer to process and understand the patterns and structures of language. In some examples, the SDS 310 leverages an LLM 399 and/or other generative model trained on the documentation of provider network services as well as application documentation and code examples of applications hosted by or on that interface with services of the cloud provider network. The SDS 310 can also leverage a more general-purpose LLM 399 trained on a larger variety of texts. Other models 398 can include code generation models, such as a GPT model, which may be within the same family as LLMs 399 but trained and/or fine-tuned on a corpus more narrowly curated to software development documents (e.g., application code, comments, documentation, programming books, etc.) rather than general texts encompassing a range of other fields. A code generation model used to create AI-generated code/syntactically complete code completions for an SDS as described herein may include a reference tracker or origin tracker feature, which can identify when outputs of some threshold size (e.g. line(s) of code, number of words/tokens) are similar to or the same as instances of its training data and then provide metadata about that training data (e.g., author, license terms such as an open source license, link to original source repository) to the user. In some examples, the code completion agent 109, upon terminating a code completion generation and formation of a syntactically complete code completion, may reference or be trained on the code repository 316 to determine if the syntactically complete code completion meets some threshold size (e.g. line(s) of code, number of words/tokens), such that if it is similar to or the same as instances of code constructs in the code repository 316, and then provide metadata about that training data (e.g., author, license terms such as an open source license, link to original source repository) to the user. Regardless of the source, the SDS 310 can receive such metadata and display it to the user 101 so that the user can decide whether they would like to accept or modify the AI-generated syntactically complete code completion or ask for a different generated syntactically complete code completion.

In the illustrated example, the SDS 310 further includes an SDS user interface (“UI”) controller 314. The SDS UI controller 314 can manage interactions between the SDS 310 and a user interface such as the chat-based interface 106 or development environment 107, interactions between the user interfaces 106 and 107 (e.g., to reflect inputs/outputs on the development environment), and interactions between agent results and the user interfaces (e.g., to display the syntactically complete code completions on the development environment 107).

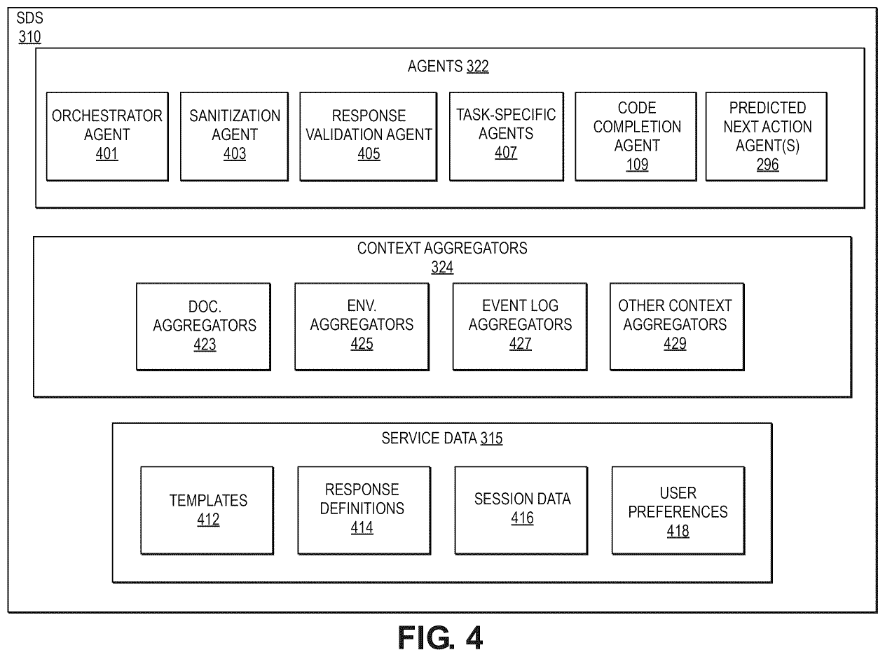

FIG. 4 depicts additional details of a software development service (“SDS”) 310 according to some examples. Agents 322 include various task-specific agents 407 as well as other general agents that support SDS interactions with an LLM 399. Example general agents include an orchestrator agent 401 that can manage a session with a client, a sanitization agent 403 that can ensure prompts and responses are within the scope of various tasks or do not venture into sensitive or objectionable material, a response validation agent 405 that can evaluate LLM responses against expected results, and a code completion agent 109 that interfaces with a development environment 107 and an AI system to generate and return syntactically complete code completions based on input code, for example.

In some examples, the orchestrator agent 401 can be the default agent executed upon connection by an application to the SDS 310 with a chat-based interface 106. Depending on the initial user prompt, the orchestrator agent 401 can identify the task requested to be performed and invoke the associated task-specific agent 407. The orchestrator agent 401 leverages an LLM 399 to determine whether a given prompt falls within a supported set of tasks and to identify which task-specific agent 407 should be invoked.

In some examples, the sanitization agent 403 reduces the likelihood of the LLM 399 providing objectionable or off-topic responses. Such responses may be artifacts of the LLM operations. Having received a response, a sanitization agent 403 can prompt the LLM 399 (or another LLM, or another instance of the LLM without a saved context) with questions related to the nature of the response, such as to test whether the response contains objectionable material, whether the response is related to the expected field of use (e.g., software development, error resolutions, etc.).

In some examples, the response validation agent 405 (or “validation agent”) verifies that an LLM response conforms with the response definition of the preceding prompt. The response validation agent 405 can perform a variety of validations. Example validations include prompting the LLM (or another LLM, or another instance of the LLM without a saved context) with a question as to whether the received response conforms with the response definition of the previous prompt, testing whether the downstream software that processes the response can successfully parse it (e.g., parsing the response in a try-catch statement), etc.

As discussed further below, the code completion agent 109 may interact with AI systems to generate a syntactically complete code completion corresponding to a code of a user operating, for example, in a development environment 107, determine when to terminate the code completion generation and return the completed code completion to the development environment 107 for presentation to the user as a syntactically complete code completion, or storage in a cache.

Example task-specific agents 407 include agents that assist clients with a given task. For example, a system design agent can assist a client in gathering additional information to provide to the LLM to improve the LLM's response to a software development task (e.g., syntactically complete code completion generation), a development task agent can assist a client dividing a development task into sub-tasks or actions. An error resolution agent may automatically debug and resolve errors on behalf of the user and/or determine an efficient resolution to eliminate errors and provide guidance to the user. In some examples, the interface 311 of FIG. 3 can support requests that invoke a particular task-specific agent 407 without relying on the orchestrator agent 401. For example, one API call can invoke the system design agent, another can invoke the development task agent, and another can invoke the error resolution agent.

Context aggregators 324 gather context about a given software system's environment to be provided to an LLM as part of the prompt expansion/creation operations of the SDS 310. Such additional data can range from general documentation applicable to a prompt to specific source code associated with a given component of the software system. Agents 322 can invoke context aggregators, in some cases depending on a previous response from an LLM identifying which additional context would assist it in generating a response. Using the information obtained from the invoked context aggregator(s), agents 322 can provide at least some of that information as additional context in subsequent prompts sent to the LLM.

Some context aggregators 324 can retrieve information from other cloud-hosted services of a provider network or other reachable sources (e.g., sources with public facing APIs external to the provider network). One example of such information is source code and configuration data, which can provide relevant context to an LLM. Another service of the provider network 100 may be a code repository service that stores source code, documentation, and other configuration data in repositories for various client applications.

In some examples, context aggregators 324 retrieve information about a particular software system. Such may be the case when a client of the SDS 310 has engaged it for a task associated with an existing system. The client can provide references to the various cloud-hosted services that include details about the system to the SDS 310, and the context aggregators 324 can retrieve that data. In other examples, context aggregators 324 retrieve information about other software systems owned by or otherwise accessible to a principal—typically the identity that was used to authenticate a client. The principal may be a user, group of users, organizational unit within a business, etc. The SDS 310 can leverage context aggregators 324 to retrieve details about the other systems of the principal.

Often environmental parameters can have an effect on software program operations. Such environmental parameters can extend from the particulars of the operating system environment variables in which the application is running to the overall cloud-based environment, the latter particularly so when the application is hosted in a provider network. For example, another service of the provider network 100 may be a permissions service (e.g., an identity and access management service). Such a permissions service can include policies that define the various actions that principals can take or that various actions that can be taken upon hosted resources, thus impacting application execution. An environment aggregator 425 can access the permissions service to obtain permissions data associated with an identified software program.

Logged events and/or errors can also provide context regarding a development task, particularly when troubleshooting bugs or other errors. Another service 394 of the provider network 100 may be a logging service in which events, errors, and other types of activity related to applications executing in the cloud are recorded. An event log aggregator 427 can access the logging service to obtain logs associated with an identified software system.

General documentation related to a service or API can also provide useful context without being specifically associated with a particular application or user. Other types of more specific documentation can also be helpful. Such documentation can include software project descriptions, software documentation, source code files, ticketing systems, and the like from other public software programs or systems. Another service 394 of the provider network 100 may be a documentation service that stores such documentation. A documentation aggregator 423 can use Retrieval Augmented Generation (“RAG”) techniques to identify documents of “relevance” to a given task. Initially, each of the available documents, or portions thereof, with the documentation service can be encoded as an embedding, those embeddings stored in a database. When invoked, the documentation aggregator 423 can use the encoder to generate an embedding from user text for the given task. The documentation aggregator 423 can then identify relevant documents based on the distance between the task embedding and document embeddings in the database, selecting the N nearest document embeddings, document embeddings within some distance threshold, or some other criteria to identify documents having embeddings in proximity to the task embedding. The documentation aggregator 423 can then access the documentation service to obtain the documents associated with those selected embeddings.

Similarly, RAG may be used to determine portions of similar code. For example, a code can be treated as a document and an embedding generated for the code. Alternatively, or in addition thereto, the code may be processed with the disclosed implementations to segment the code into portions as code constructs and an embedding generated and stored for each code construct of the code. In such an example, and as discussed further below, instead of requesting a predicted next token from an AI system, to segment a code into multiple code constructs, the disclosed implementations may process through characters of the existing code to determine where to segment the code into syntactically complete code constructs (segments). Accordingly, the same implementations to determine syntactically complete code completions from AI system generated tokens may be used to process tokens generated for an existing code to segment the file into multiple different code constructs (segments).

Other context aggregators 429 may generate annotated context from data obtained by other context aggregators. For example, some context aggregators can compile and annotate data retrieved by other aggregators into a summary. Such a context aggregator can indicate, for each of the other context aggregators that retrieved data or other information, a description of the source of the information. As another example, some context aggregators may generate structural summaries of a software system. Cloud-hosted software systems are often structured as a collection of interacting services with user code running on various resources to coordinate those interactions. A system map (or “architectural map” or just “map”) can describe the structure of a software system. The structure can include details like programs, the cloud-level infrastructure or resources on which those programs are executed, the interconnection of those programs through various data transfers (e.g., API calls, passing JSON objects, etc.), environmental configuration data (e.g., environment variables available to the programs, variables that configure the resources on which programs execute, etc.), network-level configuration data (e.g., VPC configuration data, configuration data of virtual network components like routers or gateways, etc.). In some examples, a system map of the structure of a software system may have been previously defined (e.g., by the developer). In other examples, a system map context aggregator can generate a system map that provides a description of the software system.

Service data 315 can include templates 412, response definitions 414, session data 416, and user preferences 418. Templates 412 can include templates that provide additional text cues beyond what might otherwise be provided by a user. For example, a user might provide a prompt such as “generate code to perform task X.” A prompt template can encapsulate the user's prompt with various cues that improve the quality of the response of the LLM. One pattern used by agents associated with various tasks described herein is a template to prompt the LLM to ask questions (e.g., “You will be asked to respond to the following prompt: ‘generate code to perform task X.’ What information would assist you in your response?”). Prompt templates can be used to expand prompts received from various clients (a human user typing a software error into an issue tracking system that later submits an API call to the SDS is likely to use the same abbreviated language as a human user typing an error into a chat session with an LLM). Templates 412 can also include response templates for responses to be sent to clients, populated with data received from the LLM and/or actions taken by the SDS (e.g., generation of code).

Response definitions 414 define how the SDS 310 will expect the response from the LLM 399 to be formatted. Response definitions 414 can be used to regularize the responses from LLMs to improve the ability of the SDS 310 to parse those responses such that they can be stored, trigger follow on actions, etc. Example response definitions include instructing the LLM 399 to respond in natural language forms such as with a Yes or No, a list of items, an enumerated list of items, etc., and also to respond with more structured forms (e.g., with Python® code, with an SQL query, with a JSON object, etc.). Note that the interpretation of responses pursuant to response definitions is typically contingent on the phrasing of a prompt, tailored within a given agent (e.g., a negative response might indicate a pass for one prompt, a failure for another).

Session data 416 can include the historical dialogue with an LLM 399, as mediated by the SDS 310. Not all prompts that the SDS 310 submits to an LLM 399 originate from a client, nor does the SDS 310 send all responses from the LLM 399 to the client. For this reason, the session data can include metadata about LLM interactions (e.g., whether a prompt originated from the SDS 310 or a client, whether a response from the LLM 399 was sent to a client). For example, while a client may submit a prompt of “can you generate code to perform function X,” the SDS may send a prompt to the LLM of “please provide one or more potential code components that when executed will perform function X.”

User preferences 418 can include stored user preferences based on prior dialogs with a client. In particular, the system design agent can elicit information from the client regarding preferences. Such preferences can include things such as preferred programming language (e.g., to instruct the LLM when requesting syntactically complete code completions), preferred compute options for cloud-hosted applications (e.g., whether a virtual machine, container, serverless function, etc.), permissions preferences (e.g., whether a certain set of principals can access the application), etc.

While not shown, the service data 315 can include other data such as the types of tasks the SDS 310 can support (typically those associated with the available task-specific agents) as well as the types of additional information or context that can be gathered (typically associated with the available context aggregators).

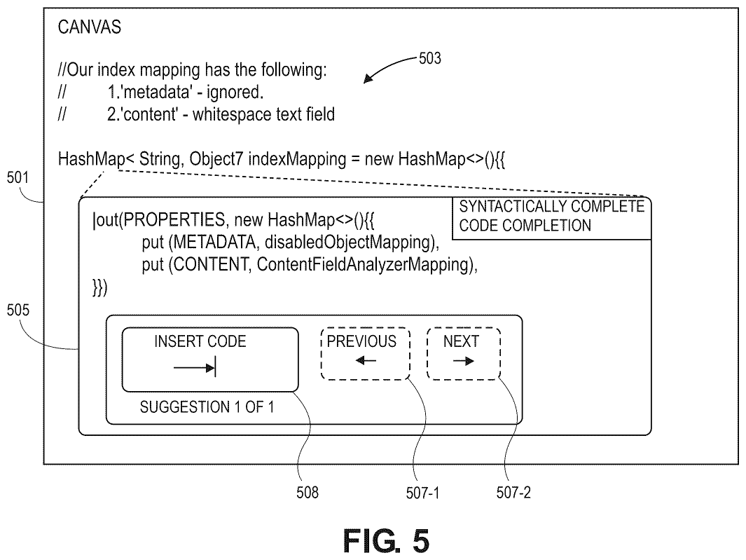

FIG. 5 is an example illustration of a development environment interface 501 that includes user code 503 and a presented syntactically complete code completion 505 determined based on the user code 503, according to exemplary implementations of the present disclosure. The development environment interface 501 may be implemented on an electronic device 105 that interfaces with the SDS 310, as depicted in FIG. 3, or hosted as part of the SDS 310. The development environment interface 501 may implement a code editor (e.g., a text editor) which may allow a user to enter code 503 in a programming language. The code completion agent 109 of the SDS 310 may analyze the entered characters of the user code 503, provide tokens for those characters/words to an AI system to receive one or more predicted next tokens, generate a syntactically complete code completion based on those received one or more predicted next tokens, and determine when to terminate generation of a code completion and return the code completion for presentation as a syntactically complete code completion, which may be displayed and added, as indicated at 505. Although not illustrated, various other information regarding the syntactically complete code completion 505, such as the source of the code, licensing information for the code, and/or various other code metadata (e.g., style guidelines) may also be displayed with or as part of the syntactically complete code completion 505. Likewise, in some implementations, the disclosed implementations may generate multiple syntactically complete code completions, each of which may be presented to the user, and the user may view each of the syntactically complete code completions through the previous control 507-1 and next control 507-2 and ultimately select to insert a syntactically complete code completion through selection of the insert code control 508. Additionally, in accordance with the disclosed implementations, when a user accepts a presented syntactically complete code completion, a pre-generated and cached syntactically complete code completion that is dependent upon the acceptance of the presented syntactically complete code completion may be immediately displayed as a next syntactically complete code completion for consideration and possible addition to the code.

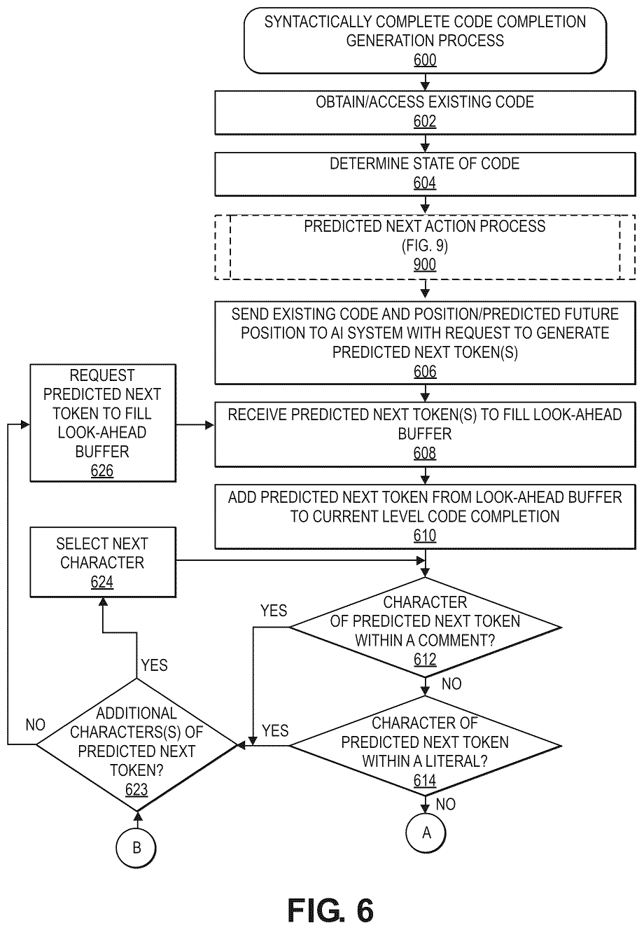

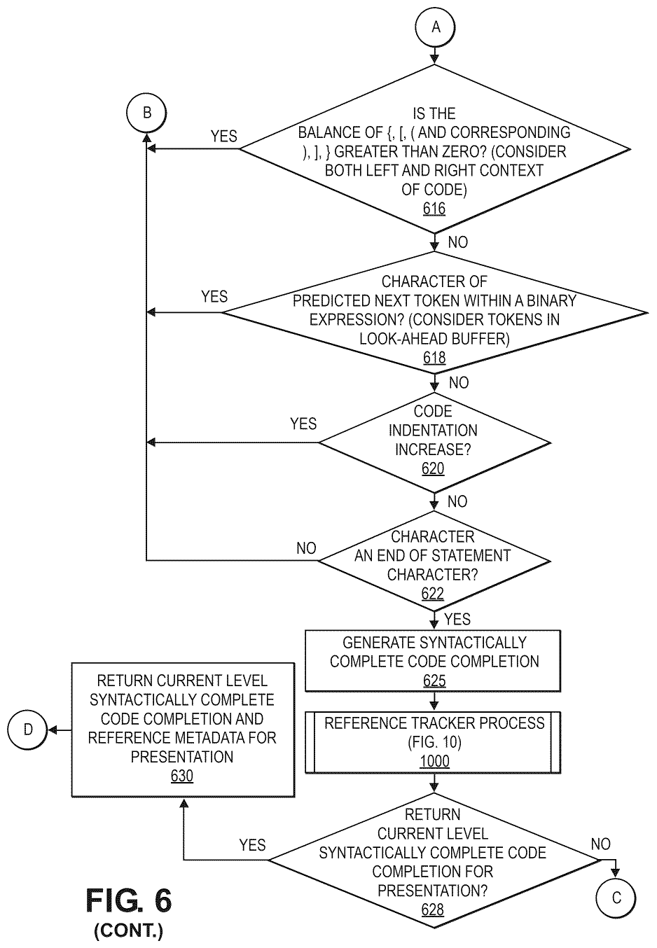

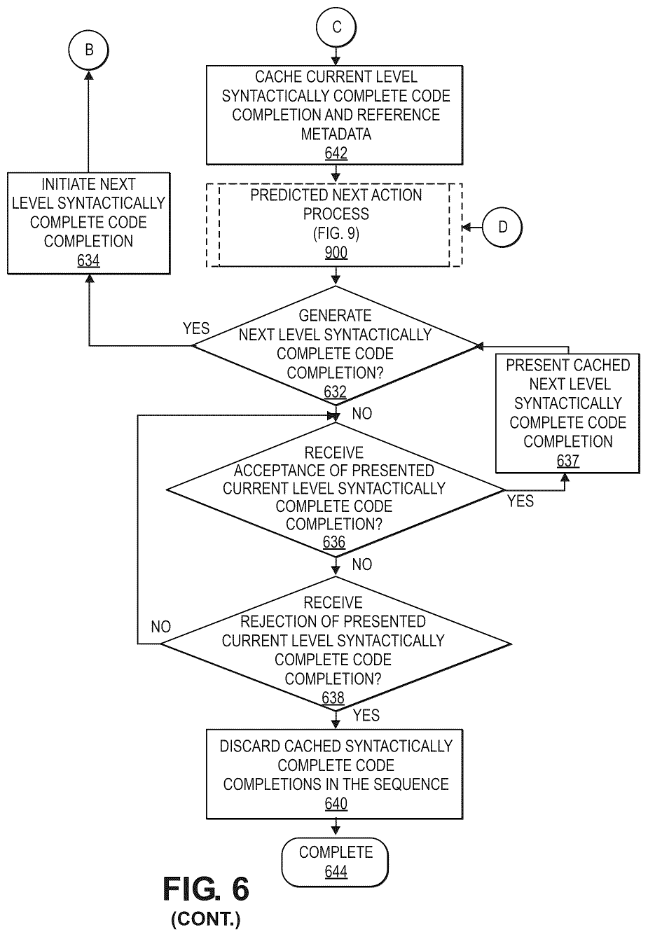

FIG. 6 is an example syntactically complete code completion generation process 600, according to exemplary implementations of the present disclosure. The example process 600 may be performed by the code completion agent 109 of the SDS 310 to determine when to terminate generation of a code completion as a syntactically complete code completion and return the syntactically complete code completion.

The example process 600 begins by obtaining or accessing an existing code, as in 602. As discussed above, a development environment 107 may be utilized by a user to create code. As the user creates the code, tokens of generated code (e.g., character tokens, word tokens, etc.) may be sent from the development environment 107 to the SDS 310 and received by the code completion agent 109. In other implementations, the entire code may be sent to the SDS/code completion agent.

Upon receipt of the code, the example process may analyze the code and the current cursor position within the code to determine the current state of the code, as in 604. In some implementations, code state, code context, etc., may already be determined and maintained in a development environment state that is provided to the SDS and the code agent. In other implementations, the code completion agent may process the received code and/or tokens of the code to determine the current state of the code.

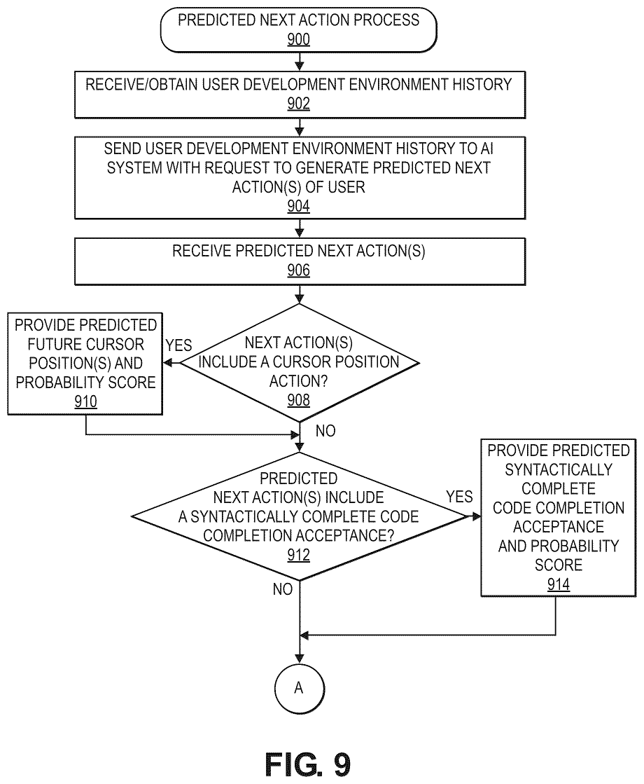

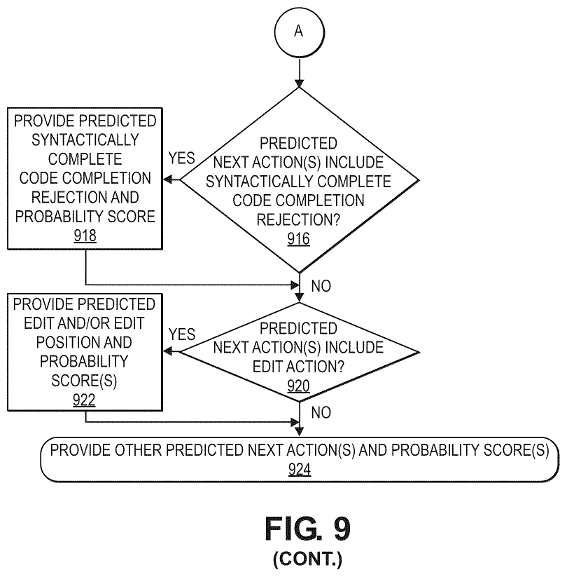

In some implementations, the predicted next action process 900, discussed further below with respect to FIG. 9, may be performed to determine a predicted next action of the user with respect to the code and/or the development environment. A predicted next action may be, for example, a predicted future cursor position at which the user may place a cursor (next action) within the code, a predicted edit to be made by the user, a prediction as to whether the user will accept a currently displayed syntactically complete code completion, a prediction as to whether the user will reject a currently displayed syntactically complete code completion, etc.

In addition to determining the state of the code, the existing code (or a portion thereof), cursor position or predicted future cursor position (predicted next action) within the code and optionally the code state, context, etc., relevant to the code may be sent to an AI system, such as an LLM or GPT, with a request to generate a predicted next token(s) based on the received information, as in 606. For example, N tokens preceding the cursor position/predicted future cursor position and M tokens following the cursor position may be sent to the AI system with a request that the AI system generate and return a predicted next token(s) that is predicted to appear at the cursor position within the code/predicted future cursor position within the code. In some implementations, when the code is initially sent to the AI system, it may be requested that the AI system provide a defined number (e.g., five, eight, ten) of predicted next tokens that may be utilized to populate a look-ahead buffer that includes one or more predicted next tokens.

The AI system, processes the received code, cursor position, etc., determines one or more predicted next tokens and returns the one or more predicted next tokens, which is received by the example process 600, as in 608. If multiple predicted next tokens are received, the received predicted next tokens may be added to a look-ahead buffer that may be utilized by the example process to obtain and add a predicted next token of the received predicted next tokens to a current level code completion. As discussed above, in some implementations the AI system may be a general AI system that processes input and generates a requested output. In other implementations, the AI system may be a specific model, such as a GPT that has been trained on code constructs such as code constructs from a code repository that is specifically trained to produce AI-generated code, such as predicted next tokens for insertion in a code as part of a code completion.

Upon receipt of the predicted next token(s), the example process 600 adds a predicted next token from the look-ahead buffer to a current level code completion, as in 610. For example, the first predicted next token in the look-ahead buffer may be removed from the look-ahead buffer and added to the current level code completion. In addition, the example process iterates over each character of the token to determine if a predicted next token should be requested or if the current level code completion generation should be terminated and the current level code completion returned as a syntactically complete code completion.

For example, the example process may process the first character of the token to determine if the character of the predicted token is within a comment, as in 612. As discussed above, it may be determined that the character is within a comment if the character is within a single line comment (e.g., // or #) or a multi-line comment (e.g., /* . . . */ or “”“. . . ”“”). In some implementations, the example process 600 may consider both code that is on the left side of the cursor position (i.e., code before the position for which the syntactically complete code completion is being generated) and code that is on the right side of the cursor position (i.e., code after the position for which the syntactically complete code completion is being generated) to determine if the character is within a comment. If the example process 600 determines that the character is within a comment, the character is not to be considered in determining whether to complete the code completion as a syntactically complete code completion.

If the character is not within a comment (i.e. the character is outside of a comment), the example process may determine if the character of the predicted next token is within a literal, as in 614. As is known, a literal is a notation that allows representation of a fixed value in a code. Literals may be used to specify constant values of different data types, such as numbers, strings, characters, or Boolean values. Example literals include number literals, string literals, character literals, Boolean literals, null literals, and other literals. Number literals represent an integer or floating point values. Examples of number literals include, but are not limited to 42 (integer literal), 3.14 (floating point literal), 0x2A (hexadecimal literal), and 0b101010 (binary literal). String literals represent a sequence of characters enclosed in quotes (single or double quotes). Examples of string literals include, but are not limited to “Hello, World!” (double-quoted string literal) and ‘foo’ (single-quoted string literal). Character literals represent a single character enclosed in single quotes. An example character literal includes ‘a’. Boolean literals represent the logical values true or false. Null literals represent a non-existent or invalid value, such as null. Other literals include additional literal notations that may be specific to programming language and/or used for specific notation. Examples of other literals include, but are not limited to [1, 2, 3] (array literal in JavaScript®), {name: “John”, age: 30} (object literal in JavaScript®), and ‘c:\path\to\file’ (raw string literal in Python®). As discussed above, it may be determined that the character is within a literal if the character is inside or bounded by a literal, such as string literals (e.g., “. . . ” or ‘. . . ’), character literals (e.g., ‘c’), or template literals (e.g., ′″. . . ′″). In some implementations, the example process 600 may consider both code that is on the left side of the cursor position/predicted future cursor position (i.e., code before the position for which the syntactically complete code completion is being generated) and code that is on the right side of the cursor position/predicted future cursor position (i.e., code after the position for which the syntactically complete code completion is being generated) to determine if the character is bounded a literal. If the process 600 determines that the character is bounded by a literal, the character is not to be considered in determining whether to complete the code completion as a syntactically complete code completion.

If it is determined that the character being iterated upon is not within a comment and not bounded by a literal (i.e., the character is outside of a comment and outside of a literal), the example process 600 may determine if the balance of {, [, (and corresponding) , ], } (curly braces, brackets, and parentheses) is greater than zero at the character, as in 616. For example, the example process 600 determines the current state of the code, including the current position/predicted future position of the character being iterated upon. If there are more opening parentheses, opening brackets, and/or opening curly braces than corresponding closing parentheses, closing brackets, and/or closing curly braces it may be determined that the balance of parentheses, brackets, and curly braces is greater than zero at the character. In some implementations, the example process 600 may consider both code that is on the left side of the cursor position/predicted future cursor position (i.e., code before the position for which the syntactically complete code completion is being generated) and code that is on the right side of the cursor position/predicted future cursor position (i.e., code after the position for which the syntactically complete code completion is being generated) to determine if balance of parentheses, brackets, and curly braces is greater than zero at the character.

If it is determined that the balance of opening parentheses, opening brackets, and opening curly braces and corresponding closing parentheses, closing brackets, and closing curly braces at the character is not greater than zero (i.e., the balance is zero), the example process 600 may determine if the character of the predicted next token is within a binary expression, as in 618. For example, it may be determined that that character is within a binary expression by looking for operator characters (e.g.,. =, !, >, <,-, +, *, /, %, ?,:, &, |, \hat{ }) in characters prior to the cursor position/predicted future cursor positions, characters of the token, and/or characters of other predicted next tokens included in the look-ahead buffer. If the character is between two operators, the character is considered to be in the middle of a binary expression. In some implementations, the example process may utilize a sliding window of a defined number of tokens (e.g., 3 tokens, 5 tokens, 8 tokens) stored in the look-ahead buffer so the example process can look ahead at characters in tokens following the current character to determine if the current character is within a binary expression.

If it is determined that the character being iterated upon is not within a comment, not bounded by a literal (i.e., the character is outside of a comment and outside of a literal), that the balance of opening parentheses, opening brackets, and opening curly braces and corresponding closing parentheses, closing brackets, and closing curly braces is zero, and that the character being iterated upon is not within a binary expression, the example process 600 may optionally determine if there is a code indentation increase in the code, as in 620. This may be an optional step and may, in some implementations, only be performed for programming languages like Python® and YAML that utilize code indentations to indicate an end of a code statement. For example, if the code indentation increases, such an increase indicates that the code statement is not complete. Comparatively, unchanged or decreases in code indentations are indications of an end of a code statement.

If it is determined that the character being iterated upon is not within a comment, not bounded by a literal (i.e., the character is outside of a comment and outside of a literal), that the balance of opening parentheses, opening brackets, and opening curly braces and corresponding closing parentheses, closing brackets, and closing curly braces is zero, that the character being iterated upon is not within a binary expression, and optionally that there is no increase in the code indentation, the example process 600 may optionally determine if the character being iterated upon is an end of statement character, as in 622. This may be an optional step and may, in some implementations, only be performed for programming languages that utilize end of statement characters. Still further, in some implementations, for programming languages that use end of statement characters, this step may further be refined to only consider the end of statement character(s) utilized by the programming language under consideration. For example, the determination as to whether the current character being iterated upon is an end of statement character when the programming language is Java®, C, C++, JavaScript®, PHP®, or Swift® may determine if the current character is a semicolon. Similarly, the determination for the Python® programming language may determine whether the current character is a colon. For programming languages like Pascal and Ada, it may be determined whether the current character is a period.

If it is determined that the character is any one of within a comment (612), within a literal (614), that the balance of opening parentheses, opening brackets, and opening curly braces and corresponding closing parentheses, closing brackets, and closing curly braces is greater than zero (616), that the character is within a binary expression (618), and/or optionally if there is an code indentation increase (620) and/or that the character is not an end of statement character (622), the example process 600 determines if there are additional characters of the predicted next token to process, as in 623. If there are additional characters of the predicted next token to process, the example process selects the next character of the token, as in 624, returns to block 612 and continues with processing the next character of the predicted next token.

If it is determined at decision block 622 that there are no additional characters of the predicted next token, the example process makes another call to the AI system and requests a predicted next token to add to the end of the look-ahead buffer, as in 626, returns to block 608 in which the predicted next token is received, and continues.

In comparison, if it is determined that the character is not inside a comment (612), not within a literal (614), the balance of opening parentheses, opening brackets, and opening curly braces and corresponding closing parentheses, closing brackets, and closing curly braces is zero (616), that the character is not in the middle of a binary expression (618) (i.e., the character is outside the binary expression), and optionally that there is no code indentation increase (620) and/or optionally that the character is an end of statement character (622), the example process determines that the current level code completion is complete and code completion generation should be terminated to form a syntactically complete code completion, as in 625. By confirming that characters of a predicted token satisfy each of the discussed criteria, the example process stops the generation and generates a syntactically complete code completion at a more meaningful and syntactically correct position, avoiding incomplete or incorrect code completions and resulting code completions that could occur with traditional systems that may determine to return a code completion that is incomplete (e.g., at the end of a line).

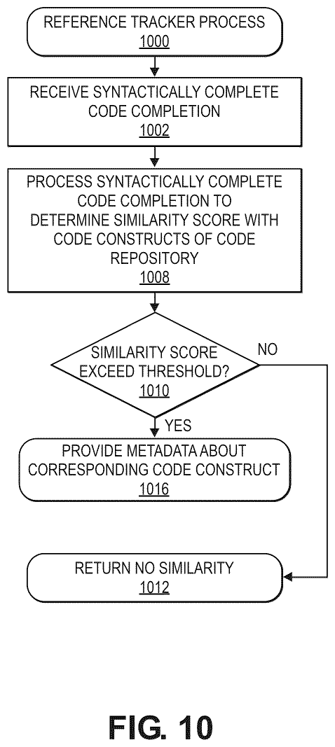

In some implementations, with each generated syntactically complete code completion, the reference tracker process 1000, discussed below with respect to FIG. 10, may be performed to determine if metadata corresponding to the syntactically complete code completion should be included with the syntactically complete code completion. FIG. 10 is discussed further below. Likewise, in some implementations other and/or additional processing of the generated current level syntactically complete code completion, such as hallucination detection, security/regulatory processing, sanitization, validation, etc., may also be performed.

In addition to optionally completing the reference tracker process 1000 and/or other processing of the syntactically complete code completion, a determination is made as to whether the current level syntactically complete code completion is to be returned for presentation to the user within the development environment, as in 628. If it is determined that the completed current level syntactically complete code completion is to be returned for presentation, the example process 600 returns the completed current level syntactically complete code completion as a syntactically complete code completion for presentation to a user at a position within a code, and optionally any determined reference data can be presented to the user for their attribution consideration, etc., as in 630.

If it is determined that the completed current level syntactically complete code completion is not to be returned for presentation to the user, the completed current level syntactically complete code completion is cached or otherwise stored, along with any reference metadata associated with the syntactically complete code completion so that the completed current level syntactically complete code completion is available for immediate or near immediate presentation upon an acceptance of a prior level syntactically complete code completion, as in 642. As discussed, the example process 600 may be utilized to generate multiple sequential levels of syntactically complete code completions so that syntactically complete code completions can be quickly presented to user, whether it be a first syntactically complete code completion or a series of syntactically complete code completions that are successively presented and accepted by the user. By caching multiple syntactically complete code completions, when the user accepts a currently displayed syntactically complete code completion, a next level syntactically complete code completion can be retrieved from the cache and presented to the user with little to no latency perceived by the user. In some implementations, the cached levels of syntactically complete code completions may be stored in a cache of the provider network. In other implementations, the cached levels of syntactically complete code completions may be stored in a cache or other memory of the client device used by the user to interact with the development environment.

After caching the completed current level syntactically complete code completion (642) or after returning the completed current level syntactically complete code completion for presentation (630), in some implementations, the predicted next action process 900, discussed further below with respect to FIG. 9, may be performed and the results used to help guide the example process 600 to determine whether to generate a next level syntactically complete code completion. For example, the predicted next action process 900 may generate a predicted next action and, in some implementations, a probability score indicating a confidence in the predicted next action.

The example process 600 may then determine whether to generate a next level syntactically complete code completion, as in 632. In some examples, the example process may generate a defined number of levels of syntactically complete code completions (e.g., two, three, four), each level generated based on an assumption that prior levels of syntactically complete code completions are accepted and included in the code. In other examples, the example process may consider the predicted next action determined by the example process 900 to determine if a next level syntactically complete code completion is to be generated. For example, if the predicted next action is a prediction that the next action of the user will be to move the cursor to a different position within the code, it may be determined that a next level syntactically complete code completion is not to be generated and instead, the example process 600 is to be restarted at the different position within the code. As another example, if the predicted next action is that the user will accept the currently presented next action, the example process 600 may determine that a next level syntactically complete code completion is to be generated. As discussed further below with respect to FIG. 10, a variety of different predicted next actions may be generated and, optionally, probability scores may be generated for one or more of the predicted next actions.

If it is determined that a next level syntactically complete code completion is to be generated, the next level syntactically complete code completion is initiated, as in 634, and the example process 600 returns to decision block 623 and continues processing characters/tokens as if the prior generated syntactically complete code completion(s) have been accepted and included in the code.

If it is determined that a next level syntactically complete code completion is not to be generated, a determination is made as to whether an acceptance of a presented current level syntactically complete code completion has been received, as in 636. In some implementations, if a defined number of levels of syntactically complete code completions have been generated the example process 600 may await acceptance of a currently presented syntactically complete code completion before generating another level of a syntactically complete code completion, or before determining whether to generate another current level syntactically complete code completion. For example, if three levels of syntactically complete code completions have been generated and cached, it may be determined that the probability of a fourth level syntactically complete code completion also being accepted (in addition to the currently presented syntactically complete code completion and the three following levels of syntactically complete code completions in the cache) is too low to justify the generation of another level syntactically complete code completion. However, when the currently presented syntactically complete code completion is accepted and added to the code and the next level syntactically complete code completion from the cache presented as the next syntactically complete code completion, the probability of another syntactically complete code completion level being accepted may be high enough to consider generating another level syntactically complete code completion.

In still other examples, the number of syntactically complete code completions at each level and/or the number of levels of each sequence of syntactically complete code completions may be dependent upon, for example, the load on the computing systems of the provider network, user preferences, compute capacity, cost, etc. For example, if low latency is of high importance, the number of levels of syntactically complete code completions may be increased so that a next syntactically complete code completion may be immediately presented numerous times in response to successive accepts of presented syntactically complete code completions. As another example, if multiple options at each level is of high importance, the number of sequences of syntactically complete code completions may be increased as an alternative to or in addition to the number of levels of syntactically complete code completions. Likewise, as each presented syntactically complete code completion is accepted, additional levels and/or sequences of syntactically complete code completions may be generated and cached. If a sufficient number of sequences and/or levels of syntactically complete code completions are generated and cached, as presented syntactically complete code completions are accepted and additional sequences/levels of syntactically complete code completions generated and cached, from the perception of the user, syntactically complete code completions may continuously be immediately available for presentation and acceptance.

Accordingly, if it is determined that an acceptance of a presented code current level syntactically complete code completion is received, the next cached level syntactically complete code completion is presented as a next syntactically complete code completion, as in 637, and the example process 600 returns to decision block 632 and continues by determining whether to generate a next level syntactically complete code completion. If it is determined that an acceptance of the presented current level syntactically complete code completion has not been received, a determination is made as to whether a rejection of the current level syntactically complete code completion has been received, as in 638. If it is determined that the presented current level syntactically complete code completion has not been rejected, the example process returns to decision block 636 and awaits an acceptance or rejection of the presented current level syntactically complete code completion. However, if it is determined that the presented current level syntactically complete code completion has been rejected, all cached next level syntactically complete code completions in that sequence of syntactically complete code completions are discarded, as in 640, and the process completes as in 644. As discussed above, because all subsequent levels of syntactically complete code completions are dependent upon the acceptance of the prior or current syntactically complete code completion, such as the presented current level syntactically complete code completion, when the presented current level syntactically complete code completion is rejected, the cached next level syntactically complete code completions become obsolete. While the cached next level syntactically complete code completions for the sequence of syntactically complete code completions generated by the example process 600 may be discarded, other sequences of levels of syntactically complete code completions generated by parallel processing of the example process 600 may be maintained and continue. For example, if another presented current code level completion of another sequence is accepted, the cached next level syntactically complete code completion for that sequence is maintained.

Accordingly, while the example process 600 describes the generation of possibly multiple levels of syntactically complete code completions, with each level of syntactically complete code completion dependent on the acceptance of the prior level of syntactically complete code completion, the example process 600 may be run in parallel multiple times to generate different sequences of syntactically complete code completions at each level and each of the different syntactically complete code completions at the current level presented as syntactically complete code completions to the user. When one of the presented syntactically complete code completions is accepted, the sequence of levels of syntactically complete code completions corresponding to the accepted syntactically complete code completion continues while the other sequences of levels of syntactically complete code completions may be discarded.

In addition to providing complete and correct syntactically complete code completions, the disclosed implementations are programming language agnostic because the disclosed implementations do not rely on any specific rules or heuristics of a particular programming language to determine when to complete generation of a syntactically complete code completion. Instead, and contrary to existing systems, the disclosed implementations utilize a unified approach, such as that discussed above, based on syntax tree programming, which works across multiple programming languages. As a result, the code and compute requirements for determining syntactically complete code completions for any of a multitude of different programming languages is greatly simplified to a single unified system, rather than a code specific system for each programming language, as is required with traditional systems.

While the example process 600 is illustrated as performing each of the code completion state determinations (decision blocks 612-622) as being performed sequentially, it will be appreciated that some or all of the code completion state determinations (612-622) may be performed in parallel. Likewise, multiple instances of the example process 600 may be performed, for example in parallel, to generate multiple sequences of levels of syntactically complete code completions.

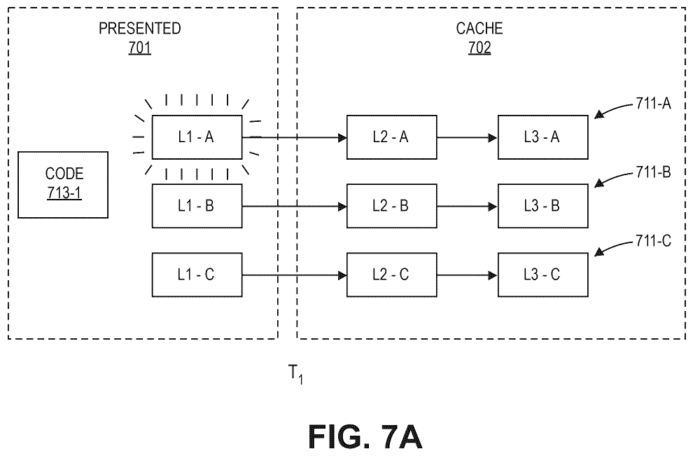

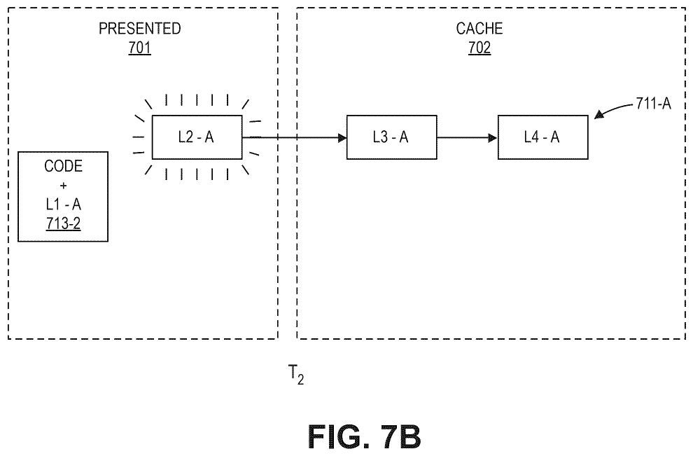

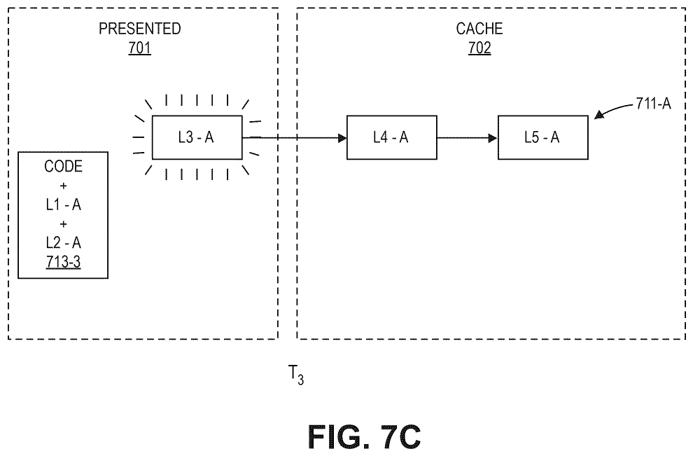

FIGS. 7A through 7C is a logical block diagram illustrating the presentation of syntactically complete code completions and the caching of additional syntactically complete code completions over a period of time, according to exemplary implementations of the present disclosure.

As illustrated in FIG. 7A, at a first time (T₁), the example process 600 may be performed three times in parallel to generate three different sequences of levels of syntactically complete code completions 711-A, 711-B, 711-C. In the illustrated example, a first sequence of levels of syntactically complete code completions 711-A includes a current level syntactically complete code completion L1-A that is presented 701 to the user through the development environment with the code 713-1, a second level syntactically complete code completion L2-A that is maintained in the cache 702 and a third level syntactically complete code completion L3-A that is maintained in the cache. The second sequence of levels of syntactically complete code completions 711-B includes a current level syntactically complete code completion L1-B that is presented 701 to the user through the development environment with the code 713-1, a second level syntactically complete code completion L2-B that is maintained in the cache 702 and a third level syntactically complete code completion L3-B that is maintained in the cache 702. The third sequence of levels of syntactically complete code completions 711-C includes a current level syntactically complete code completion L1-C that is presented 701 to the user through the development environment with the code 713-1, a second level syntactically complete code completion L2-C that is maintained in the cache 702 and a third level syntactically complete code completion L3-C that is maintained in the cache 702. Example presentations of syntactically complete code completions, such as syntactically complete code completions L1-A, L1-B, L1-C are discussed above with respect to FIG. 5. In the illustrated example, the user accepts the L1-A syntactically complete code completion.

Turning to FIG. 7B, which illustrates the sequence of levels of syntactically complete code completions at time 2 (T₂) after the user has accepted the L1-A syntactically complete code completion that was presented at T₁. As illustrated, the accepted syntactically complete code completion L1-A is added to the code 713-2 in response to the acceptance and the two sequences of levels of syntactically complete code completions 711-B, 711-C that are not in the sequence with the accepted syntactically complete code completion L1-A are discarded. Likewise, what was the second level syntactically complete code completion L2-A in the sequence with the accepted syntactically complete code completion L1-A is obtained and presented 701 with the code 713-2 as a syntactically complete code completion and a next level syntactically complete code completion L4-A is generated by the example process 600 and added to the cache 702. In the illustrated example, the user accepts the L2-A syntactically complete code completion.

Turning to FIG. 7C, which illustrates the sequence of levels of syntactically complete code completions at time 3 (T₃) after the user has accepted the L2-A syntactically complete code completion that was presented at T₂. As illustrated, the accepted syntactically complete code completion L2-A is added to the code 713-3, in addition to syntactically complete code completion L1-A, in response to the acceptance. Likewise, what was the third level syntactically complete code completion L3-A in the sequence with the accepted syntactically complete code completion L2-A is obtained and presented 701 with the code 713-3 as a syntactically complete code completion and a next level syntactically complete code completion L5-A is generated by the example process 600 and added to the cache 702. This process of moving syntactically complete code completions from the cache to presentation following acceptance of a syntactically complete code completion and generation/addition of a next level syntactically complete code completion to the cache may continue until a presented syntactically complete code completion is rejected.

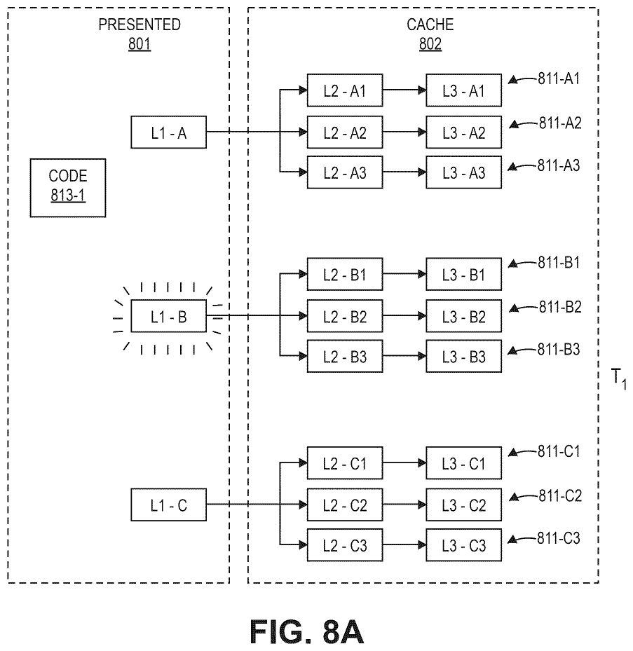

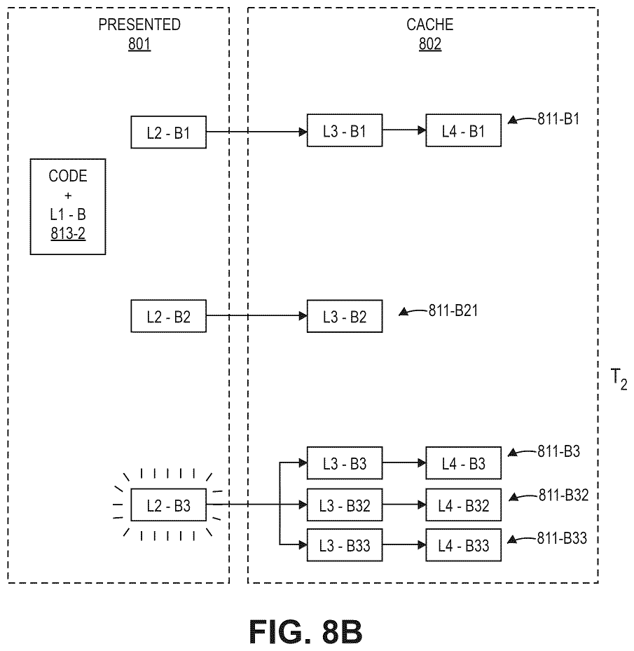

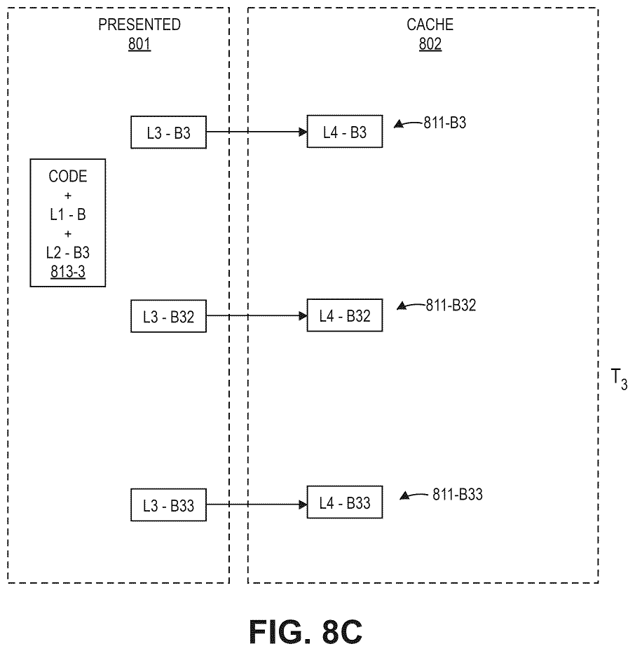

FIGS. 8A through 8C is another logical block diagram illustrating the presentation of syntactically complete code completions and the caching of additional syntactically complete code completions over a period of time, according to exemplary implementations of the present disclosure.

As illustrated in FIG. 8A at a fist time (T₁) the example process 600 may be performed three times to generate three different first level syntactically complete code completions L1-A, L1-B, L1-C and then performed three additional times for each of the three first level syntactically complete code completions to generate three different sequences of cached next level syntactically complete code completions for each first level syntactically complete code completion L1-A, L1-B, L1-C. For example, after generating a first, first level syntactically complete code completion L1-A the example process may be continued forward from that first level syntactically complete code completion L1-A in parallel three times to generate three additional sequences 811-A1, 811-A2, 811-A3. In the first parallel sequence 811-A1, the example process generates two additional levels of syntactically complete code completions L2-A1 and L3-A1. In the second parallel sequence 811-A2, the example process generates two additional levels of syntactically complete code completions L2-A2 and L3-A2. In the third parallel sequence 811-A3 the example process generates two additional levels of syntactically complete code completions L2-A3 and L3-A3. Similarly, after generating a second, first level syntactically complete code completion L1-B, the example process may be continued forward from that first level syntactically complete code completion L1-B in parallel three times to generate three additional sequences 811-B1, 811-B2, 811-B3. In the first parallel sequence 811-B1, the example process generates two additional levels of syntactically complete code completions L2-B1 and L3-B1. In the second parallel sequence 811-B2, the example process generates two additional levels of syntactically complete code completions L2-B2 and L3-B2. In the third parallel sequence 811-B3 the example process generates two additional levels of syntactically complete code completions L2-B3 and L3-B3. Likewise, after generating a third, first level syntactically complete code completion L1-C, the example process may be continued forward from that first level syntactically complete code completion L1-C in parallel three times to generate three additional sequences 811-C1, 811-C2, 811-C3. In the first parallel sequence 811-C1, the example process generates two additional levels of syntactically complete code completions L2-C1 and L3-C1. In the second parallel sequence 811-C2, the example process generates two additional levels of syntactically complete code completions L2-C2 and L3-C2. In the third parallel sequence 811-C3 the example process generates two additional levels of syntactically complete code completions L2-C3 and L3-C3.

In the illustrated example, the user accepts the L1-B syntactically complete code completion.

Turning to FIG. 8B, which illustrates the sequence of levels of syntactically complete code completions at time 2 (T₂) after the user has accepted the L1-B syntactically complete code completion that was presented at T₁. As illustrated, the accepted syntactically complete code completion L1-B is added to the code 813-2 in response to the acceptance and the other sequences of levels of syntactically complete code completions 811-A1, 811-A2, 811-A3, 811-C1, 811-C2, and 811-C3 that are not in a sequence with the accepted syntactically complete code completion L1-B are discarded. Likewise, what was the second level syntactically complete code completions L2-B1, L2-B2, and L2-B3 in the sequence with accepted first level syntactically complete code completion L1-B, are obtained and presented 801 with the code 813-2 as syntactically complete code completions L2-B1, L2-B2, L2-B3. Still further, in the illustrated example, the predicted next action process is performed and it is determined that a next level syntactically complete code completion L4-B1 is to be generated that is subsequent to syntactically complete code completion L3-B1, that no additional levels of code completions are to be generated for the sequence of syntactically complete code cocompletions 811-B21 that includes syntactically complete code completion L2-B2 and L3-B2, that another level of syntactically complete code completions is to be added to the sequence of syntactically complete code completions extending from syntactically complete code completion L2-B3, namely syntactically complete code completion sequence 811-B3, and that additional sequences of code completions 811-B32 and 811-B33 are to be generated.

For example, the new sequence of syntactically complete code completions 811-B32 that follows syntactically complete code completion L2-B3 may include new next level (third) syntactically complete code completion L3-B32 and another level (fourth) syntactically complete code completion L4-B32. Likewise, the new sequence of syntactically complete code completions 811-B33 that follows syntactically complete code completion L2-B3 may include new next level (third) syntactically complete code completion L3-B33 and another level (fourth) syntactically complete code completion L4-B33. As illustrated and as discussed herein, the predicted next action process 900 may be used to determine a predicted next action and confidence scores that the predicted next action will actually be performed. As illustrated in FIG. 8B, it is determined that a predicted next action of syntactically complete code completion L2-B3 being accepted is low enough that additional levels of syntactically complete code completions in the sequence that includes syntactically complete code completion L2-B2 are not generated. Comparatively, it is determined that there is a high probability that the syntactically complete code completion L2-B3 will be selected and, as a result, additional sequences and levels of syntactically complete code completions are generated.

In the illustrated example, the user accepts the L2-B3 syntactically complete code completion.

Turning to FIG. 8C, which illustrates the sequence of levels of syntactically complete code completions at time 3 (T₃) after the user has accepted the L2-B3 syntactically complete code completion that was presented at T₂. As illustrated, the accepted syntactically complete code completion L2-B3 is added to the code 813-3 along with previously added syntactically complete code completion L1-B in response to the acceptance. Likewise, what was the third level syntactically complete code completions L3-B3, L3-B32, and L3-B33 in the sequence with accepted second level syntactically complete code completion L2-B3, are obtained and presented 801 with the code 813-3 as syntactically complete code completions L3-B3, L3-B32, L3-B33 and the syntactically complete code completions in the sequence with L2-B1 and L2-B2, namely syntactically complete code completions L3-B1, L4-B1, and L3-B2 are discarded. Additionally, and again based on the predicted next actions, there is low confidence that any of the currently presented syntactically complete code completions L3-B3, L3-B32, L3-B33 will be accepted followed by an acceptance of a next level syntactically complete code completion in those sequences 811-B3, 811-B32, 811-B33, so it is determined that the system will refrain from generating any additional syntactically complete code completions for those sequences. As a result and in this example, the cache 802 only contains the syntactically complete code completions L4-B3, L4-B32, and L4-B33 of sequences 811-B3, 811-B32, and 811-B33, respective that were previously generated.

This process of moving syntactically complete code completions from the cache to presentation following acceptance of a syntactically complete code completion, discarding syntactically complete code completions from the cache that are not included in the sequence with an accepted syntactically complete code completion, and predicting and then selectively generating and adding additional next level syntactically complete code completions to the cache to fill out and extend each sequence of syntactically complete code completions may continue until all presented syntactically complete code completions are rejected and/or until it is determined that there is a low probability that additional syntactically complete code completions will be presented/accepted and therefore should not be generated.

As illustrated in FIGS. 7A through 8C, any variety of levels and combinations of generations of sequences of levels of syntactically complete code completions may be generated with the disclosed implementations. Accordingly, the examples discussed with respect to FIGS. 7A through 8C are provided only as examples.

FIG. 9 is an example predicted next action process 900, that can be used in the software development environment of FIG. 3, according to exemplary implementations of the present disclosure.

The example process 900 begins by receiving or obtaining user development environment history, as in 902. User development environment history may be provided in the form of a log file, action history record, etc. Generally described, the user development environment history may be a file that includes a textual representation of each action (e.g., file open, file close, file save, placement of cursor at a position within a file, text edit, text entry, etc.) performed by the user through the development environment. In some implementations, the user development environment history may include all actions ever performed by the user through the development environment. In other examples, the user development environment history may include all actions performed by the user through the development environment over a defined period of time (e.g., last seven days, last 30 days, etc.) and/or actions performed by the user with respect to a particular file or files, etc.

The user development environment history may then be sent to an AI system, such as an LLM or other AI system that has been trained or tuned to predict next actions within a development environment by a user based on the user's development environment history, as in 904. Because the user development environment history may be a text based file such as a log file of all user actions, an AI system, such as an LLM, can be trained or fine-tuned on a large corpus of user development environment history files to predict, based on a current user's user development environment history, one or more next actions predicted to be performed by the user. Because the user development environment history files do not include actual code generated by users, but instead only actions performed, there is no risk of code leakage or code sharing by training or tuning an AI system with a large corpus of user development environment history files.

Returning to block 904, in some examples, the request sent to the AI system with the user development environment history may be a request that the AI system predict the next most likely action(s) to be taken by the user and optionally request that the AI system provide a probability score indicating a confidence that the predicted next action(s) will actually be performed. In other examples, the request may be a request for a defined number (e.g., 2, 3, 5, etc.) of predicted next actions and optionally probability scores indicating a confidence that each of the predicted next actions will actually occur. In still other examples, the request may include an indication of possible next actions (e.g., cursor position, acceptance of currently presented syntactically complete code completion, rejection of current presented syntactically complete code completion, file edit, etc.) and a request that the AI system provide a probability score for each of those possible next actions indicating the probability that the user will perform the next action.

After sending the user development environment history and the request to the AI system, the example process receives a response from the AI system that includes one or more predicted next actions and optionally probability scores indicating the confidence or likelihood that the user will actually perform the predicted next action, as in 906.

A determination may then be made as to whether the returned predicted next action(s) include a cursor position action, as in 908. For example, if the most recent action in the user development environment history is an open file action, the predicted next action will likely be a cursor position action of the user placing the cursor at a particular position within the opened file. If the returned predicted next actions include a cursor position action, the predicted future cursor position within a file may be returned to the example process 600, discussed above, along with a probability score indicating a probability that the cursor position action will actually occur, as in 910.

After returning the predicted future cursor position (910), or if it is determined at decision block 908 that the predicted next action(s) does not include a cursor position action, a determination may be made as to whether the predicted next action(s) include a syntactically complete code completion acceptance action, as in 912. For example, if the most recent action in the user development environment history is the presentation of a syntactically complete code completion, the predicted next action may be a syntactically complete code completion acceptance. If the returned predicted next action(s) include a syntactically complete code completion acceptance action, the predicted syntactically complete code completion acceptance and optionally a probability score determined for the predicted syntactically complete code completion acceptance action may be returned to the example process 600, discussed above, as in 914.

After returning the predicted syntactically complete code completion acceptance (914), or if it is determined at decision block 912 that the predicted next action(s) does not include a syntactically complete code completion acceptance action, a determination may be made as to whether the predicted next action(s) include a syntactically complete code completion rejection action, as in 916. For example, if the most recent action in the user development environment history is the presentation of a syntactically complete code completion, the predicted next action may be a syntactically complete code completion rejection. If the returned predicted next action(s) include a syntactically complete code completion rejection action, the predicted syntactically complete code completion rejection and optionally a probability score determined for the predicted syntactically complete code completion rejection action may be returned to the example process 600, discussed above, as in 918.

After returning the predicted syntactically complete code completion rejection (918), or if it is determined at decision block 916 that the predicted next action(s) does not include a syntactically complete code completion rejection action, a determination may be made as to whether the predicted next action(s) include an edit action (e.g., adding code, changing code, removing code), as in 920. For example, based on the fine tuning of the AI system with a large corpus of user development environment histories, the AI system may identify that there is a large correlation between an edit action following a syntactically complete code completion acceptance action or following a cursor position action, etc. Accordingly, based on the provided user development environment history of the user, the AI system may predict, based on that history, that the next action will be an edit action. If it is determined that the returned predicted next action(s) include an edit action, the predicted edit action and/or a predicted edit action position within the code, and optionally a probability score determined for the predicted edit action may be returned to the example process 600, discussed above, as in 922.

Finally, after returning the predicted edit action (922) or if it is determined at decision block 920 that the predicted next action(s) does not include an edit action, any other predicted next action and optionally the probability scores for those other predicted next actions, may be returned to the example process 600, as in 924, and the example process 900 completes.

FIG. 10 is an example reference tracker process 1000, according to exemplary implementations of the present disclosure.

The example process 1000 begins by receiving a syntactically complete code completion that is to be processed for reference tracking consideration, as in 1002. As noted above, the example reference tracker process 1000 may be performed upon termination of the generation of a syntactically complete code completion by the example process 600 (FIG. 6) and the completed syntactically complete code completion provided to the example reference tracker process 1000. Upon receipt of a completed syntactically complete code completion, the syntactically complete code completion is processed to determine a similarity score with one or more code constructs of a code repository, as in 1008. As discussed above, the code repository 316 may include code and/or code constructs that were used, for example, to train an AI system that was utilized to generate the syntactically complete code completion being processed. As a result, AI-generated code, such as a syntactically complete code completion, may be substantially similar to an existing code construct and thus potentially relevant for consideration as to any licenses or other obligations relating to the existing code.

In some implementations, processing of the syntactically complete code completion may include a textual analysis or comparison of the text of the syntactically complete code completion with the text of stored code constructs from the code repository to determine a similarity score indicative of a similarity between the code construct and one or more of the stored code constructs. In other implementations, a syntactically complete code completion embedding may be generated as a mathematical representation of the code construct and with stored code construct embeddings of code constructs from the code repository to determine a similarity score indicative of a similarity between the code construct and one or more stored code constructs. Generation of embedding vectors from code is known in the art and need not be discussed in detail herein. In still other examples, the syntactically complete code completion may be provided to an AI-system with instructions that the AI-system determine a similarity score indicative of a similarity between the syntactically complete code completion and the one or more stored code constructs.

Regardless of the technique used, a determination may be made as to whether any of the similarity scores exceed a threshold, as in 1010. The threshold may be any value, indicator, or other reference that, if exceeded, is indicative of the syntactically complete code completion being considered similar to a stored code construct such that metadata regarding the stored code construct should be included or associated with the code construct. If it is determined that none of the code similarity scores exceed the threshold, an indication of no similarity is returned for the syntactically complete code completion, the no similarity indication indicative of a determination that the syntactically complete code completion is not significantly similar to any stored code construct, as in 1012. If it is determined at decision block 1010 that one or more of the similarity scores exceed the threshold, metadata about the stored code construct(s) for which the similarity score(s) is determined to exceed the threshold may be added to or otherwise associated with the syntactically complete code completion, as in 1016. As discussed above, metadata about the stored code construct may include, but is not limited to, author, license terms such as an open source license, link to original code repository, etc. The metadata may be returned with the syntactically complete code completion and associated or presented with the syntactically complete code completion. For example, when the syntactically complete code completion is presented and metadata is associated with that syntactically complete code completion, the metadata may be presented to the user with the syntactically complete code completion so that the user can decide whether they would like to accept or modify the syntactically complete code completion or ask for a different generated syntactically complete code completion.

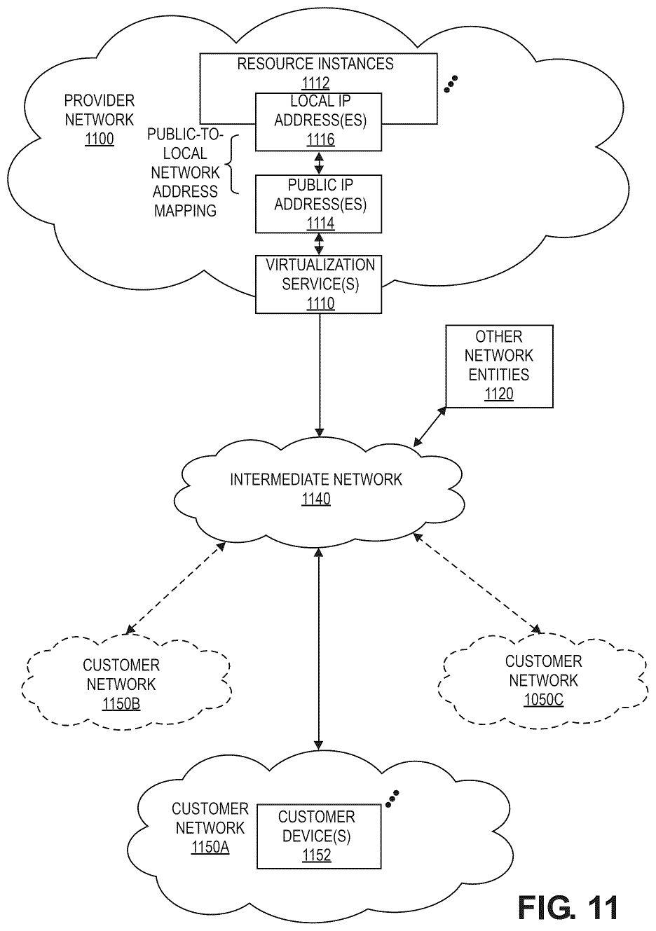

FIG. 11 illustrates an example provider network (or “service provider system”) environment according to some examples. A provider network 1100 can provide resource virtualization to customers via one or more virtualization services 1110 that allow customers to purchase, rent, or otherwise obtain instances 1112 of virtualized resources, including but not limited to computation and storage resources, implemented on devices within the provider network or networks in one or more data centers. Local Internet Protocol (IP) addresses 1116 can be associated with the resource instances 1112; the local IP addresses are the internal network addresses of the resource instances 1112 on the provider network 1100. In some examples, the provider network 1100 can also provide public IP addresses 1114 and/or public IP address ranges (e.g., Internet Protocol version 4(IPv 4 ) or Internet Protocol version 6(IPv 6 ) addresses) that customers can obtain from the provider 1100.

Conventionally, the provider network 1100, via the virtualization services 1110, can allow a customer of the service provider (e.g., a customer that operates one or more customer networks 1150A, 1150B, 1150C (or “client networks”) including one or more customer device(s) 1152) to dynamically associate at least some public IP addresses 1114 assigned or allocated to the customer with particular resource instances 1112 assigned to the customer. The provider network 1100 can also allow the customer to remap a public IP address 1114, previously mapped to one virtualized computing resource instance 1112 allocated to the customer, to another virtualized computing resource instance 1112 that is also allocated to the customer. Using the virtualized computing resource instances 1112 and public IP addresses 1114 provided by the service provider, a customer of the service provider such as the operator of the customer network(s) 1150A-1150C can, for example, implement customer-specific applications and present the customer's applications on an intermediate network 1140, such as the Internet. Other network entities 1120 on the intermediate network 1140 can then generate traffic to a destination public IP address 1114 published by the customer network(s) 1150A-1150C; the traffic is routed to the service provider data center, and at the data center is routed, via a network substrate, to the local IP address 1116 of the virtualized computing resource instance 1112 currently mapped to the destination public IP address 1114. Similarly, response traffic from the virtualized computing resource instance 1112 can be routed via the network substrate back onto the intermediate network 1140 to the source entity 1120.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 1100; a customer can then assign their allocated public IP addresses to particular resource instances allocated to the customer. These public IP addresses can be referred to as customer public IP addresses, or simply customer IP addresses. Instead of being assigned by the provider network 1100 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

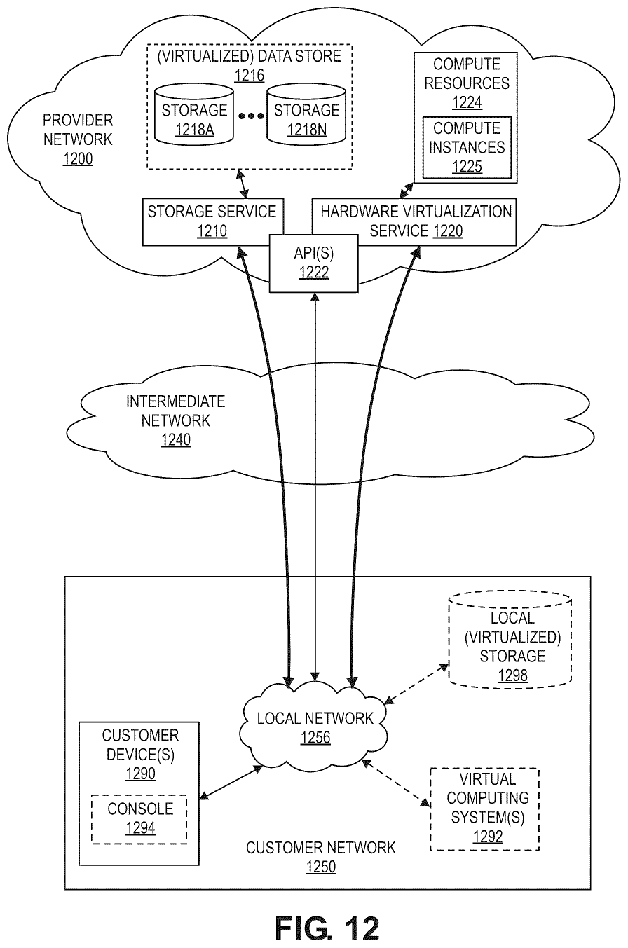

FIG. 12 is a block diagram of an example provider network environment 1200 that provides a storage service and a hardware virtualization service to customers, according to some examples. A hardware virtualization service 1220 provides multiple compute resources 1224 (e.g., compute instances 1225, such as VMs) to customers. The compute resources 1224 can, for example, be provided as a service to customers of a provider network 1200 (e.g., to a customer that implements a customer network 1250). Each computation resource 1224 can be provided with one or more local IP addresses. The provider network 1200 can be configured to route packets from the local IP addresses of the compute resources 1224 to public Internet destinations, and from public Internet sources to the local IP addresses of the compute resources 1224.

The provider network 1200 can provide the customer network 1250, for example coupled to an intermediate network 1240 via a local network 1256, the ability to implement virtual computing systems 1292 via the hardware virtualization service 1220 coupled to the intermediate network 1240 and to the provider network 1200. In some examples, the hardware virtualization service 1220 can provide one or more APIs 1222, for example a web services interface, via which the customer network 1250 can access functionality provided by the hardware virtualization service 1220, for example via a console 1294 (e.g., a web-based application, standalone application, mobile application, etc.) of a customer device 1290. In some examples, at the provider network 1200, each virtual computing system 1292 at the customer network 1250 can correspond to a computation resource 1224 that is leased, rented, or otherwise provided to the customer network 1250.

From an instance of the virtual computing system(s) 1292 and/or another customer device 1290 (e.g., via console 1294), the customer can access the functionality of a storage service 1210, for example via the one or more APIs 1222, to access data from and store data to storage resources 1218A-1218N of a virtual data store 1216 (e.g., a folder or “bucket,” a virtualized volume, a database, etc.) provided by the provider network 1200. In some examples, a virtualized data store gateway (not shown) can be provided at the customer network 1250 that can locally cache at least some data, for example frequently accessed or critical data, and that can communicate with the storage service 1210 via one or more communications channels to upload new or modified data from a local cache so that the primary store of data (the virtualized data store 1216) is maintained. In some examples, a user, via the virtual computing system 1292 and/or another customer device 1290, can mount and access virtual data store 1216 volumes via the storage service 1210 acting as a storage virtualization service, and these volumes can appear to the user as local (virtualized) storage 1298.

While not shown in FIG. 12, the virtualization service(s) can also be accessed from resource instances within the provider network 1200 via the API(s) 1222. For example, a customer, appliance service provider, or other entity can access a virtualization service from within a respective virtual network on the provider network 1200 via the API(s) 1222 to request allocation of one or more resource instances within the virtual network or within another virtual network.

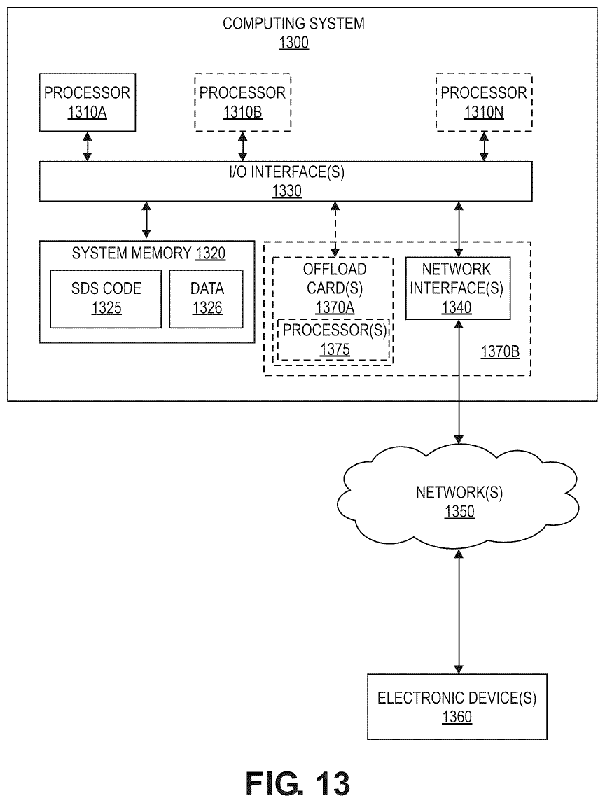

In some examples, a system that implements a portion or all of the techniques described herein can include a general-purpose computer system, such as the computer system 1300 (also referred to as a computing device or electronic device) illustrated in FIG. 13, that includes, or is configured to access, one or more computer-accessible media. In the illustrated example, the computer system 1300 includes one or more processors 1310 coupled to a system memory 1320 via an input/output (I/O) interface 1330. The computer system 1300 further includes a network interface 1340 coupled to the I/O interface 1330. While FIG. 13 shows the computer system 1300 as a single computing device, in various examples the computer system 1300 can include one computing device or any number of computing devices configured to work together as a single computer system 1300.

In various examples, the computer system 1300 can be a uniprocessor system including one processor 1310, or a multiprocessor system including several processors 1310A-1310N (e.g., two, four, eight, or another suitable number). The processor(s) 1310 can be any suitable processor(s) capable of executing instructions. For example, in various examples, the processor(s) 1310 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 1310 can commonly, but not necessarily, implement the same ISA.

The system memory 1320 can store instructions and data accessible by the processor(s) 1310. In various examples, the system memory 1320 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 1320 as SDS code 1325 (e.g., executable to implement, in whole or in part, an LLM service such as those described herein) and data 1326.

In some examples, the I/O interface 1330 can be configured to coordinate I/O traffic between the processor 1310, the system memory 1320, and any peripheral devices in the device, including the network interface 1340 and/or other peripheral interfaces (not shown). In some examples, the I/O interface 1330 can perform any necessary protocol, timing, or other data transformations to convert data signals from one component (e.g., the system memory 1320) into a format suitable for use by another component (e.g., the processor 1310). In some examples, the I/O interface 1330 can include support for devices attached through various types of peripheral buses, such as a variant of the Peripheral Component Interconnect (PCI) bus standard or the Universal Serial Bus (USB) standard, for example. In some examples, the function of the I/O interface 1330 can be split into two or more separate components, such as a north bridge and a south bridge, for example. Also, in some examples, some or all of the functionality of the I/O interface 1330, such as an interface to the system memory 1320, can be incorporated directly into the processor 1310.

The network interface 1340 can be configured to allow data to be exchanged between the computer system 1300 and other electronic devices 1360 attached to a network or networks 1350, such as other computer systems or devices as illustrated in FIG. 1, for example. In various examples, the network interface 1340 can support communication via any suitable wired or wireless general data networks, such as types of Ethernet network, for example. Additionally, the network interface 1340 can support communication via telecommunications/telephony networks, such as analog voice networks or digital fiber communications networks, via storage area networks (SANs), such as Fibre Channel SANs, and/or via any other suitable type of network and/or protocol.

In some examples, the computer system 1300 includes one or more offload cards 1370A or 1370B (including one or more processors 1375, and possibly including the one or more network interfaces 1340) that are connected using the I/O interface 1330 (e.g., a bus implementing a version of the Peripheral Component Interconnect-Express (PCI-E) standard, or another interconnect such as a QuickPath interconnect (QPI) or UltraPath interconnect (UPI)). For example, in some examples the computer system 1300 can act as a host electronic device (e.g., operating as part of a hardware virtualization service) that hosts compute resources such as compute instances, and the one or more offload cards 1370A or 1370B execute a virtualization manager that can manage compute instances that execute on the host electronic device. As an example, in some examples the offload card(s) 1370A or 1370B can perform compute instance management operations, such as pausing and/or un-pausing compute instances, launching and/or terminating compute instances, performing memory transfer/copying operations, etc. These management operations can, in some examples, be performed by the offload card(s) 1370A or 1370B in coordination with a hypervisor (e.g., upon a request from a hypervisor) that is executed by the other processors 1310A-1310N of the computer system 1300. However, in some examples the virtualization manager implemented by the offload card(s) 1370A or 1370B can accommodate requests from other entities (e.g., from compute instances themselves), and cannot coordinate with (or service) any separate hypervisor.

In some examples, the system memory 1320 can be one example of a computer-accessible medium configured to store program instructions and data as described above. However, in other examples, program instructions and/or data can be received, sent, or stored upon different types of computer-accessible media. Generally speaking, a computer-accessible medium can include any non-transitory storage media or memory media such as magnetic or optical media, e.g., disk or DVD/CD coupled to the computer system 1300 via the I/O interface 1330. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computer system 1300 as the system memory 1320 or another type of memory. Further, a computer-accessible medium can include transmission media or signals such as electrical, electromagnetic, or digital signals, conveyed via a communication medium such as a network and/or a wireless link, such as can be implemented via the network interface 1340.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response to requests from user devices, such as by executing one or more Web applications that can be implemented as one or more scripts or programs written in any programming language, such as Java®, C, C #or C++, or any scripting language, such as Perl®, Python®, PHP, or TCL, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 1218A-1218N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method, comprising:
receiving a request for a first level syntactically complete code completion to include in a code;
in response to the request:
generating, based at least in part on the code, a code completion;
determining that the code completion is syntactically complete when added to the code;
in response to determining that the code completion is syntactically complete, generating, from the code completion, the first level syntactically complete code completion to suggest for inclusion in the code; and
presenting the first level syntactically complete code completion as a first suggestion for acceptance in response to the request;
subsequent to generating the first level syntactically complete code completion and prior to an acceptance of the first level syntactically complete code completion:
generating, based at least in part on the code and the first level syntactically complete code completion, a second level syntactically complete code completion that:
is executable without syntax errors; and
is structured for inclusion in the code following the acceptance of the first level syntactically complete code completion; and
storing the second level syntactically complete code completion;
receiving the acceptance of the first level syntactically complete code completion; and
in response to the acceptance, in real-time or near real-time, presenting the second level syntactically complete code completion as a second suggestion for inclusion in the code.

2. The computer-implemented method of claim 1, wherein determining that the code completion is syntactically complete, further includes:
sending a first request to an artificial intelligence (“AI”) system that the AI system generate a first token;
receiving, in response to the first request, the first token;
adding the first token to the code completion as part of generating the code completion such that a first end of the first token corresponds to an end position of the code completion; and
determining, for a state of the code completion with the first token added, that:
the end position of the code completion is outside a comment;
the end position of the code completion is outside a literal;
the balance of opening parentheses, opening brackets, and opening curly braces and corresponding closing parentheses, closing brackets, and closing curly braces at the end position of the code completion is zero; and
the end position of the code completion is outside a binary expression.

3. The computer-implemented method of claim 2, wherein generating the second level syntactically complete code completion includes:
sending a second request to the AI system that the AI system generate a second token that follows the first token;
receiving, in response to the second request, the second token;
adding the second token to a second code completion as part of the generation of the second level syntactically complete code completion such that a second end of the second token corresponds to a second end position of the second code completion;
determining, for a state of the second code completion with the second token added, that:
the second end position of the second code completion is outside a comment;
the second end position of the second code completion is outside a literal;
the balance of opening parentheses, opening brackets, and opening curly braces and corresponding closing parentheses, closing brackets, and closing curly braces at the second end position of the second code completion is zero; and
the second end position of the second code completion is outside a binary expression; and
in response to the determining, generating from the second code completion the second level syntactically complete code completion such that the second level syntactically complete code completion includes the second token.

4. The computer-implemented method of claim 1, further comprising:
determining, based at least in part on a development environment history, a predicted future cursor position at which a cursor will be positioned in the code; and
wherein:
receiving the request for the first level syntactically complete code completion includes a predicted future cursor position, wherein the request is received before the cursor is actually positioned at the predicted future cursor position;
generating the first level syntactically complete code completion is based at least in part on the predicted future cursor position; and
presenting the first level syntactically complete code completion after determining that the cursor has been positioned at the predicted future cursor position.

5. The computer-implemented method of claim 1, wherein presenting the first level syntactically complete code completion includes:
presenting, in-line with a cursor position of a cursor within the code, the first level syntactically complete code completion; and
including at least one action control that allows a user to perform an action with respect to the first level syntactically complete code completion.

6. A system, comprising:
one or more processors; and
a memory storing program instructions that, when executed by the one or more processors, cause the one or more processors to at least:
generate, based on at least a portion of a code, a code completion;
determine that the code completion is syntactically complete;
generate, from the code completion, a first level syntactically complete code completion for inclusion at a first position within the code;
generate, based on at least the code and the first level syntactically complete code completion, a second level syntactically complete code completion for inclusion at a second position within the code;
cause a presentation, at the first position within a development environment, of the first level syntactically complete code completion; and
maintain the second level syntactically complete code completion in a cache without outputting the second level syntactically complete code completion to the development environment, wherein the second level syntactically complete code completion is structured for inclusion in the development environment following an acceptance of the first level syntactically complete code completion.

7. The system of claim 6, wherein the program instructions that, when executed by the one or more processors, further cause the one or more processors to at least:
receive the acceptance of the first level syntactically complete code completion; and
in response to receipt of the acceptance:
cause a second presentation of the second level syntactically complete code completion at the second position; and
include the first level syntactically complete code completion in the code at the first position.

8. The system of claim 6, wherein the program instructions that, when executed by the one or more processors, further cause the one or more processors to at least:
generate, based on at least the code, the first level syntactically complete code completion and the second level syntactically complete code completion, a third level syntactically complete code completion for inclusion at a third position within the development environment; and
maintain the third level syntactically complete code completion in the cache without outputting the third level syntactically complete code completion to the development environment, wherein the third level syntactically complete code completion is structured for inclusion in the development environment following an acceptance of the second level syntactically complete code completion.

9. The system of claim 8, wherein the program instructions that, when executed by the one or more processors, further cause the one or more processors to at least:
receive the acceptance of the first level syntactically complete code completion; and
in response to receipt of the acceptance:
cause a second presentation of the second level syntactically complete code completion at the second position in the development environment;
receive a rejection of the second level syntactically complete code completion; and
in response to the rejection, discard the second level syntactically complete code completion and the third level syntactically complete code completion.

10. The system of claim 6, wherein the program instructions that, when executed by the one or more processors, further cause the one or more processors to at least:
receive the acceptance of the first level syntactically complete code completion; and
in response to receipt of the acceptance:
include the first level syntactically complete code completion in the code at the first position;
cause a second presentation of the second level syntactically complete code completion at the second position in the development environment;
determine a predicted next action to be performed with respect to the code; and
determine, based at least in part on the predicted next action, to refrain from generating a third level syntactically complete code completion.

11. The system of claim 6, wherein the program instructions that, when executed by the one or more processors, further cause the one or more processors to at least:
receive the acceptance of the first level syntactically complete code completion; and
in response to receipt of the acceptance:
include the first level syntactically complete code completion in the code at the first position;
cause a second presentation of the second level syntactically complete code completion at the second position in the development environment;
determine a predicted next action to be performed with respect to the code is a placement of a cursor at a third position within the code;
generate, based on at least a second portion of the code that is adjacent the third position, another first level syntactically complete code completion for inclusion at the third position withing the code; and
store the another first level syntactically complete code completion in the cache.

12. The system of claim 6, wherein the cache is part of a client device upon which the code is presented.

13. The system of claim 6, wherein the program instructions that, when executed by the one or more processors, further cause the one or more processors to at least:
determine, based at least in part on a development environment history, a predicted next action to be performed by a user with respect to the code; and
wherein:
the first level syntactically complete code completion is generated based at least in part on the code and the predicted next action; and
the first level syntactically complete code completion is presented in response to a determination that the predicted next action has been performed.

14. The system of claim 13, wherein the predicted next action is at least one of a predicted future cursor position within the development environment, a predicted acceptance of a presented syntactically complete code completion, or a predicted edit to the code.

15. The system of claim 13, wherein the predicted next action is determined by an artificial intelligence (“AI”) system that has been tuned with a corpus of development environment histories of a plurality of users to determine the predicted next action and provide a probability score indicating a confidence that the predicted next action will be performed.

16. A computer-implemented method comprising:
generating a first level syntactically complete code completion by sequentially adding a first plurality of tokens produced based at least in part on a code until it is determined that the first plurality of tokens added to the first level syntactically complete code completion produces a syntactically complete code completion with respect to a portion of the code;
generating a second level syntactically complete code completion by sequentially adding a second plurality of tokens produced based at least in part on the portion of the code and the first level syntactically complete code completion;
presenting the first level syntactically complete code completion for inclusion in the code;
maintaining the second level syntactically complete code completion in a cache;
receiving an acceptance of the first level syntactically complete code completion for inclusion in the code; and
in response to receiving the acceptance:
adding the first level syntactically complete code completion to the code; and
presenting the second level syntactically complete code completion for inclusion in the code.

17. The computer-implemented method of claim 16, further comprising:
in response to the acceptance, generating a third level syntactically complete code completion by sequentially adding a third plurality of tokens produced based at least in part on the portion of the code, the first level syntactically complete code completion, and the second level syntactically complete code completion; and
maintaining the third level syntactically complete code completion in the cache.

18. The computer-implemented method of claim 17, further comprising:
receiving a rejection of the second level syntactically complete code completion; and
in response to the rejection, discarding the second level syntactically complete code completion and the third level syntactically complete code completion.

19. The computer-implemented method of claim 16, further comprising:
in response to the acceptance, determining a predicted next action to be performed with respect to the code; and
determining, based at least in part on the predicted next action, to refrain from generating a third level syntactically complete code completion.

20. The computer-implemented method of claim 16, further comprising:
in response to the acceptance, determining a predicted next action to be performed with respect to the code;
determining a placement of a cursor at a predicted future position within the code that is different than a current position;
generating, based at least in part on the code and the predicted future position, an additional first level syntactically complete code completion for presentation at the predicted future position;
maintaining the additional first level syntactically complete code completion in the cache;
determining that the cursor is positioned at the predicted future position; and
in response to determining that the cursor is positioned at the predicted future position, presenting the additional first level syntactically complete code completion.
